(19) United States
(12) Patent Application Publication
(10) Pub. No.: US 2025/0356591 A1
(43) Pub. Date: Nov. 20, 2025

(54) Normal-based Subdivision for 3D Mesh

(71) Applicant: Ofinno, LLC, Reston, VA (US)

(72) Inventors: Chao Cao, Reston, VA (US); Marta Milovanovic, Bourg-la-Reine (FR)

(73) Assignee: Ofinno, LLC, Reston, VA (US)

(21) Appl. No.: 19/207,739

(22) Filed: May 14, 2025

Related U.S. Application Data
(60) Provisional application No. 63/647,850, filed on May 15, 2024.

(51) Int. Cl. G06T 17/20

(52) U.S. Cl. CPC G06T 17/205

(57) ABSTRACT

A decoder subdivides, for a 3-dimensional (3D) mesh, a bash mesh obtained from a bitstream to generate a first subdivided mesh. To subdivide an edge, formed by a first and a second vertex from the first subdivided mesh, the decoder determines a pair of vertices, from the first subdivided mesh, used to generate the first vertex. And, the decoder determines a refinement vector based on combining vertex normals of the pair of vertices. The edge is subdivided to determine a vertex based on the refinement vector and a point along the edge. The 3D mesh is reconstructed by the decoder based on a second subdivided mesh including vertices of the first subdivided mesh and the vertex.

### CROSS-REFERENCE TO RELATED APPLICATIONS

This application claims the benefit of U.S. Provisional Application No. 63/647,850, filed May 15, 2024, which is hereby incorporated by reference in its entirety.

### BRIEF DESCRIPTION OF THE DRAWINGS

Examples of several of the various embodiments of the present disclosure are described herein with reference to the drawings.

FIG. 1 illustrates an exemplary mesh coding/decoding system in which embodiments of the present disclosure may be implemented.

FIG. 2A illustrates a block diagram of an example encoder for intra encoding a 3D mesh, according to some embodiments.

FIG. 2B illustrates a block diagram of an example encoder for inter encoding a 3D mesh, according to some embodiments.

FIG. 3 illustrates a diagram showing an example decoder.

FIG. 4 is a diagram showing an example process for generating displacements of an input mesh (e.g., an input 3D mesh frame) to be encoded, according to some embodiments.

FIG. 5 illustrates an example process for approximating and encoding a geometry of a 3D mesh, according to some embodiments.

FIG. 6 illustrates an example of vertices of a subdivided mesh (e.g., a subdivided base mesh) corresponding to multiple levels of detail (LODs), according to some embodiments.

FIG. 7A illustrates an example of an image packed with displacements (e.g., displacement fields or vectors) using a packing method, according to some embodiments.

FIG. 7B illustrates an example of the displacement image with labeled LODs, according to some embodiments.

FIG. 8 illustrates an example of a lifting scheme for representing displacement information of a 3D mesh as wavelet coefficients, according to some embodiments.

FIG. 9 illustrates a diagram of an example normal-based subdivision scheme, according to some embodiments.

FIG. 10 illustrates a diagram of an example normal-based subdivision scheme, according to some embodiments.

FIG. 11 illustrates a diagram of an example normal-based subdivision scheme, according to some embodiments.

FIG. 12 illustrates a flowchart of a method for performing normal-based subdivision for reconstructing a 3D mesh, according to some embodiments.

FIG. 13 illustrates a flowchart of a method for performing normal-based subdivision for encoding a 3D mesh, according to some embodiments.

FIG. 14 illustrates a block diagram of an exemplary computer system in which embodiments of the present disclosure may be implemented.

### DETAILED DESCRIPTION

In the following description, numerous specific details are set forth in order to provide a thorough understanding of the disclosure. However, it will be apparent to those skilled in the art that the disclosure, including structures, systems, and methods, may be practiced without these specific details. The description and representation herein are the common means used by those experienced or skilled in the art to most effectively convey the substance of their work to others skilled in the art. In other instances, well-known methods, procedures, components, and circuitry have not been described in detail to avoid unnecessarily obscuring aspects of the disclosure.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

Also, it is noted that individual embodiments may be described as a process which is depicted as a flowchart, a flow diagram, a data flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed, but could have additional steps not included in a figure. A process may correspond to a method, a function, a procedure, a subroutine, a subprogram, etc. When a process corresponds to a function, its termination can correspond to a return of the function to the calling function or the main function.

The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as compact disk (CD) or digital versatile disk (DVD), flash memory, memory or memory devices. A computer-readable medium may have stored thereon code and/or machine-executable instructions that may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

Furthermore, embodiments may be implemented by hardware, software, firmware, middleware, microcode, hardware description languages, or any combination thereof. When implemented in software, firmware, middleware or microcode, the program code or code segments to perform the necessary tasks (e.g., a computer-program product) may be stored in a computer-readable or machine-readable medium. A processor(s) may perform the necessary tasks.

Traditional visual data describes an object or scene using a series of points (or pixels) that each comprise a position in two dimensions (x and y) and one or more optional attributes like color. Volumetric visual data adds another positional dimension to this traditional visual data. Volumetric visual data describes an object or scene using a series of points that each comprise a position in three dimensions (x, y, and z) and one or more optional attributes like color. Compared to traditional visual data, volumetric visual data may provide a more immersive way to experience visual data. For example, an object or scene described by volumetric visual data may be viewed from any (or multiple) angles, whereas traditional visual data may generally only be viewed from the angle in which it was captured or rendered. Volumetric visual data may be used in many applications, including Augmented Reality (AR), Virtual Reality (VR), and Mixed Reality (MR). Volumetric visual data may be in the form of a volumetric frame that describes an object or scene captured at a particular time instance or in the form of a sequence of volumetric frames (referred to as a volumetric sequence or volumetric video) that describes an object or scene captured at multiple different time instances.

One format for storing volumetric visual data is 3D meshes (hereinafter referred to as a mesh or a mesh frame). A mesh frame (or mesh) comprises a collection of points in three-dimensional (3D) space, also referred to as vertices. Each vertex in a mesh comprises geometry information that indicates the vertex's position in 3D space. For example, the geometry information may indicate the vertex's position in 3D space using three Cartesian coordinates (x, y, and z). Further the mesh may comprise geometry information indicating a plurality of triangles. Each triangle comprises three vertices connected by three edges and a face. One or more types of attribute information may be stored for each face (of a triangle). Attribute information may indicate a property of a face's visual appearance. For example, attribute information may indicate a texture (e.g., color) of the face, a material type of the face, transparency information of the face, reflectance information of the face, a normal vector to a surface of the face, a velocity at the face, an acceleration at the face, a time stamp indicating when the face (and/or vertex) was captured, or a modality indicating how the face (and/or vertex) was captured (e.g., running, walking, or flying). In another example, a face (or vertex) may comprise light field data in the form of multiple view-dependent texture information. Light field data may be another type of optional attribute information.

The triangles (e.g., represented as vertexes and edges) in a mesh may describe an object or a scene. For example, the triangles in a mesh may describe the external surface and/or the internal structure of an object or scene. The object or scene may be synthetically generated by a computer or may be generated from the capture of a real-world object or scene. The geometry information of a real world object or scene may be obtained by 3D scanning and/or photogrammetry. 3D scanning may include laser scanning, structured light scanning, and/or modulated light scanning. 3D scanning may obtain geometry information by moving one or more laser heads, structured light cameras, and/or modulated light cameras relative to an object or scene being scanned. Photogrammetry may obtain geometry information by triangulating the same feature or point in different spatially shifted 2D photographs. Mesh data may be in the form of a mesh frame that describes an object or scene captured at a particular time instance or in the form of a sequence of mesh frames (referred to as a mesh sequence or mesh video) that describes an object or scene captured at multiple different time instances.

The data size of a mesh frame or sequence in addition with one or more types of attribute information may be too large for storage and/or transmission in many applications. For example, a single mesh frame may comprise thousands or tens or hundreds of thousands of triangles, where each triangle (e.g., vertexes and/or edges) comprises geometry information and one or more optional types of attribute information. The geometry information of each vertex may comprise three Cartesian coordinates (x, y, and z) that are each represented, for example, using 8 bits or 24 bits in total. The attribute information of each point may comprise a texture corresponding to three color components (e.g., R, G, and B color components) that are each represented, for example, using 8 bits or 24 bits in total. A single vertex therefore comprises 48 bits of information in this example, with 24 bits of geometry information and 24 bits of texture. Encoding may be used to compress the size of a mesh frame or sequence to provide for more efficient storage and/or transmission. Decoding may be used to decompress a compressed mesh frame or sequence for display and/or other forms of consumption (e.g., by a machine learning based device, neural network based device, artificial intelligence based device, or other forms of consumption by other types of machine based processing algorithms and/or devices).

Compression of meshes may be lossy (e.g., introducing differences relative to the original data) for the distribution to and visualization by an end-user, for example on AR/VR glasses or any other 3D-capable device. Lossy compression allows for a very high ratio of compression but incurs a trade-off between compression and visual quality perceived by the end-user. Other frameworks, like medical or geological applications, may require lossless compression to avoid altering the decompressed meshes.

Volumetric visual data may be stored after being encoded into a bitstream in a container, for example, a file server in the network. The end-user may request for a specific bitstream depending on the user's requirement. The user may also request for adaptive streaming of the bitstream where the trade-off between network resource consumption and visual quality perceived by the end-user is taken into consideration by an algorithm.

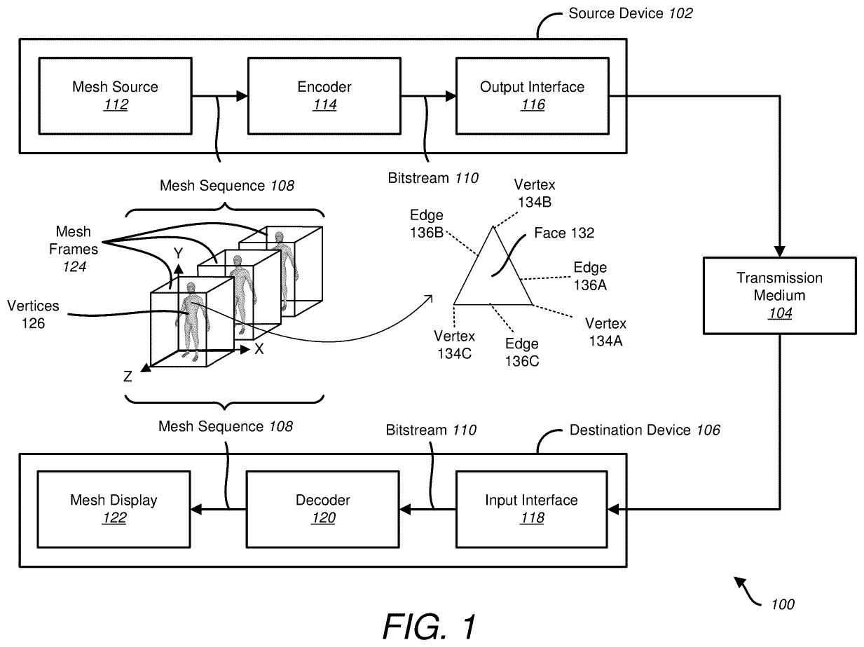

FIG. 1 illustrates an exemplary mesh coding/decoding system 100 in which embodiments of the present disclosure may be implemented. Mesh coding/decoding system 100 comprises a source device 102, a transmission medium 104, and a destination device 106. Source device 102 encodes a mesh sequence 108 into a bitstream 110 for more efficient storage and/or transmission. Source device 102 may store and/or transmit bitstream 110 to destination device 106 via transmission medium 104. Destination device 106 decodes bitstream 110 to display mesh sequence 108 or for other forms of consumption. Destination device 106 may receive bitstream 110 from source device 102 via a storage medium or transmission medium 104. Source device 102 and destination device 106 may be any one of a number of different devices, including a cluster of interconnected computer systems acting as a pool of seamless resources (also referred to as a cloud of computers or cloud computer), a server, a desktop computer, a laptop computer, a tablet computer, a smart phone, a wearable device, a television, a camera, a video gaming console, a set-top box, a video streaming device, an autonomous vehicle, or a head mounted display. A head mounted display may allow a user to view a VR, AR, or MR scene and adjust the view of the scene based on movement of the user's head. A head mounted display may be tethered to a processing device (e.g., a server, desktop computer, set-top box, or video gaming counsel) or may be fully self-contained.

To encode mesh sequence 108 into bitstream 110, source device 102 may comprise a mesh source 112, an encoder 114, and an output interface 116. Mesh source 112 may provide or generate mesh sequence 108 from a capture of a natural scene and/or a synthetically generated scene. A synthetically generated scene may be a scene comprising computer generated graphics. Mesh source 112 may comprise one or more mesh capture devices (e.g., one or more laser scanning devices, structured light scanning devices, modulated light scanning devices, and/or passive scanning devices), a mesh archive comprising previously captured natural scenes and/or synthetically generated scenes, a mesh feed interface to receive captured natural scenes and/or synthetically generated scenes from a mesh content provider, and/or a processor to generate synthetic mesh scenes.

As shown in FIG. 1, a mesh sequence 108 may comprise a series of mesh frames 124. A mesh frame describes an object or scene captured at a particular time instance. Mesh sequence 108 may achieve the impression of motion when a constant or variable time is used to successively present mesh frames 124 of mesh sequence 108. A (3D) mesh frame comprises a collection of vertices 126 in 3D space and geometry information of vertices 126. A 3D mesh may comprise a collection of vertices, edges, and faces that define the shape of a polyhedral object. Further, the mesh frame comprises a plurality of triangles (e.g., polygon triangles). For example, a triangle may include vertices 134A-C and edges 136A-C and a face 132. The faces usually consist of triangles (triangle mesh), Quadrilaterals (Quads), or other simple convex polygons (n-gons), since this simplifies rendering, but may also be more generally composed of concave polygons, or even polygons with holes. Each of vertices 126 may comprise geometry information that indicates the point's position in 3D space. For example, the geometry information may indicate the point's position in 3D space using three Cartesian coordinates (x, y, and z). For example, the geometry information may indicate the plurality of triangles with each comprising three vertices of vertices 126. One or more of the triangles may further comprise one or more types of attribute information. Attribute information may indicate a property of a point's visual appearance. For example, attribute information may indicate a texture (e.g., color) of a face, a material type of a face, transparency information of a face, reflectance information of a face, a normal vector to a surface of a face, a velocity at a face, an acceleration at a face, a time stamp indicating when a face was captured, a modality indicating when a face was captured (e.g., running, walking, or flying). In another example, one or more of the faces (or triangles) may comprise light field data in the form of multiple view-dependent texture information. Light field data may be another type of optional attribute information. Color attribute information of one or more of the faces may comprise a luminance value and two chrominance values. The luminance value may represent the brightness (or luma component, Y) of the point. The chrominance values may respectively represent the blue and red components of the point (or chroma components, Cb and Cr) separate from the brightness. Other color attribute values are possible based on different color schemes (e.g., an RGB or monochrome color scheme).

In some embodiments, a 3D mesh (e.g., one of mesh frames 124) may be a static or a dynamic mesh. In some examples, the 3D mesh may be represented (e.g., defined) by connectivity information, geometry information, and texture information (e.g., texture coordinates and texture connectivity). In some embodiments, the geometry information may represent locations of vertices of the 3D mesh in 3D space and the connectivity information may indicate how the vertices are to be connected together to form polygons (e.g., triangles) that make up the 3D mesh. Also, the texture coordinates indicate locations of pixels in a 2D image that correspond to vertices of a corresponding 3D mesh (or a sub-mesh of the 3D mesh). In some examples, patch information may indicate how the texture coordinates defined with respect to a 2D bounding box map into a 3D space of a 3D bounding box associated with the patch based on how the points were projected onto a projection plane for the patch. Also, the texture connectivity information may indicate how the vertices represented by the texture coordinates are to be connected together to form polygons of the 3D mesh (or sub-meshes). For example, each texture or attribute patch of the texture image may corresponds to a corresponding sub-mesh defined using texture coordinates and texture connectivity.

In some embodiments, for each 3D mesh, one or multiple 2D images may represent the textures or attributes associated with the mesh. For example, the texture information may include geometry information listed as X, Y, and Z coordinates of vertices and texture coordinates listed as 2D dimensional coordinates corresponding to the vertices. The example texture mesh may include texture connectivity information that indicates mappings between the geometry coordinates and texture coordinates to form polygons, such as triangles. For example, a first triangle may be formed by three vertices, where a first vertex (1/1) is defined as the first geometry coordinate (e.g. 64.062500, 1237.739990, 51.757801), which corresponds with the first texture coordinate (e.g. 0.0897381, 0.740830). A second vertex (2/2) of the triangle may be defined as the second geometry coordinate (e.g. 59.570301, 1236.819946, 54.899700), which corresponds with the second texture coordinate (e.g. 0.899059, 0.741542). Finally, a third vertex of the triangle may correspond to the third listed geometry coordinate which matches with the third listed texture coordinate. However, note that in some instances a vertex of a polygon, such as a triangle, may map to a set of geometry coordinates and texture coordinates that may have different index positions in the respective lists of geometry coordinates and texture coordinates. For example, the second triangle has a first vertex corresponding to the fourth listed set of geometry coordinates and the seventh listed set of texture coordinates. A second vertex corresponding to the first listed set of geometry coordinates and the first set of listed texture coordinates and a third vertex corresponding to the third listed set of geometry coordinates and the ninth listed set of texture coordinates.

Encoder 114 may encode mesh sequence 108 into bitstream 110. To encode mesh sequence 108, encoder 114 may apply one or more prediction techniques to reduce redundant information in mesh sequence 108. Redundant information is information that may be predicted at a decoder and therefore may not be needed to be transmitted to the decoder for accurate decoding of mesh sequence 108. For example, encoder 114 may convert attribute information (e.g., texture information) of one or more of mesh frames 124 from 3D to 2D and then apply one or more 2D video encoders or encoding methods to the 2D images. For example, any one of multiple different proprietary or standardized 2D video encoders/decoders may be used, including International Telecommunications Union Telecommunication Standardization Sector (ITU-T) H.1263, ITU-T H.1264 and Moving Picture Expert Group (MPEG)-4 Visual (also known as Advanced Video Coding (AVC)), ITU-T H.1265 and MPEG-H Part 2 (also known as High Efficiency Video Coding (HEVC), ITU-T H.1265 and MPEG-I Part 3 (also known as Versatile Video Coding (VVC)), the WebM VP8 and VP9 codecs, and AOMedia Video 1 (AV1). Encoder 114 may encode geometry of mesh sequence 108 based on video dynamic mesh coding (V-DMC). V-DMC specifies the encoded bitstream syntax and semantics for transmission or storage of a mesh sequence and the decoder operation for reconstructing the mesh sequence from the bitstream.

Output interface 116 may be configured to write and/or store bitstream 110 onto transmission medium 104 for transmission to destination device 106. In addition, or alternatively, output interface 116 may be configured to transmit, upload, and/or stream bitstream 110 to destination device 106 via transmission medium 104. Output interface 116 may comprise a wired and/or wireless transmitter configured to transmit, upload, and/or stream bitstream 110 according to one or more proprietary and/or standardized communication protocols, such as Digital Video Broadcasting (DVB) standards, Advanced Television Systems Committee (ATSC) standards, Integrated Services Digital Broadcasting (ISDB) standards, Data Over Cable Service Interface Specification (DOCSIS) standards, 3rd Generation Partnership Project (3GPP) standards, Institute of Electrical and Electronics Engineers (IEEE) standards, Internet Protocol (IP) standards, and Wireless Application Protocol (WAP) standards.

Transmission medium 104 may comprise a wireless, wired, and/or computer readable medium. For example, transmission medium 104 may comprise one or more wires, cables, air interfaces, optical discs, flash memory, and/or magnetic memory. In addition, or alternatively, transmission medium 104 may comprise one or more networks (e.g., the Internet) or file servers configured to store and/or transmit encoded video data.

To decode bitstream 110 into mesh sequence 108 for display or other forms of consumption, destination device 106 may comprise an input interface 118, a decoder 120, and a mesh display 122. Input interface 118 may be configured to read bitstream 110 stored on transmission medium 104 by source device 102. In addition, or alternatively, input interface 118 may be configured to receive, download, and/or stream bitstream 110 from source device 102 via transmission medium 104. Input interface 118 may comprise a wired and/or wireless receiver configured to receive, download, and/or stream bitstream 110 according to one or more proprietary and/or standardized communication protocols, such as those mentioned above.

Decoder 120 may decode mesh sequence 108 from encoded bitstream 110. To decode attribute information (e.g., textures) of mesh sequence 108, decoder 120 may reconstruct the 2D images compressed using one or more 2D video encoders. Decoder 120 may then reconstruct the attribute information of 3D mesh frames 124 from the reconstructed 2D images. In some examples, decoder 120 may decode a mesh sequence that approximates mesh sequence 108 due to, for example, lossy compression of mesh sequence 108 by encoder 114 and/or errors introduced into encoded bitstream 110 during transmission to destination device 106. Further, decoder 120 may decode geometry of mesh sequence 108 from encoded bitstream 110, as will be further described below. Then, one or more of decoded attribute information may be applied to decoded mesh frames of mesh sequence 108.

Mesh display 122 may display mesh sequence 108 to a user. Mesh display 122 may comprise a cathode rate tube (CRT) display, a liquid crystal display (LCD), a plasma display, a light emitting diode (LED) display, a 3D display, a holographic display, a head mounted display, or any other display device suitable for displaying mesh sequence 108.

It should be noted that mesh coding/decoding system 100 is presented by way of example and not limitation. In the example of FIG. 1, mesh coding/decoding system 100 may have other components and/or arrangements. For example, mesh source 112 may be external to source device 102. Similarly, mesh display 122 may be external to destination device 106 or omitted altogether where mesh sequence is intended for consumption by a machine and/or storage device. In another example, source device 102 may further comprise a mesh decoder and destination device 106 may comprise a mesh encoder. In such an example, source device 102 may be configured to further receive an encoded bit stream from destination device 106 to support two-way mesh transmission between the devices.

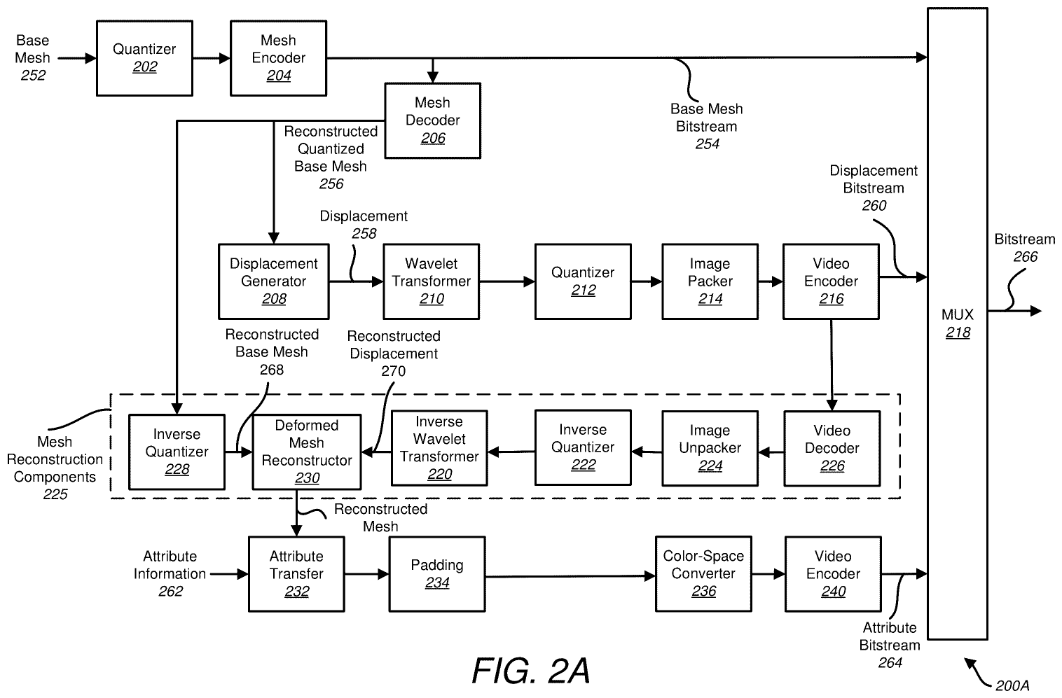

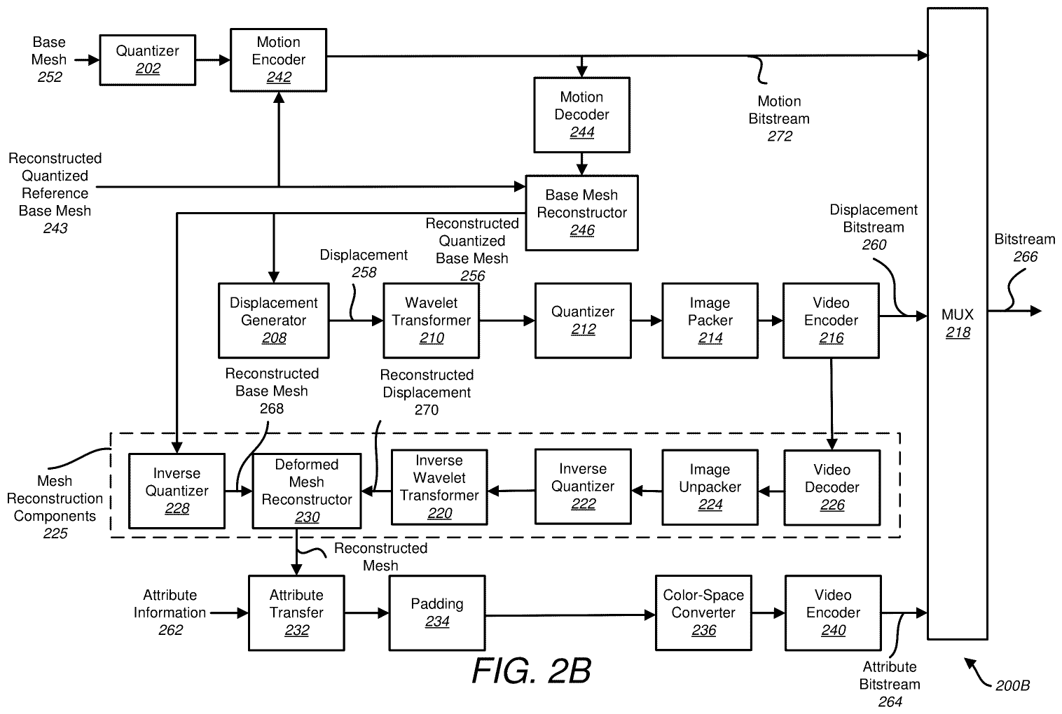

FIG. 2A illustrates a block diagram of an example encoder 200A for intra encoding a 3D mesh, according to some embodiments. For example, an encoder (e.g., encoder 114) may comprise encoder 200A.

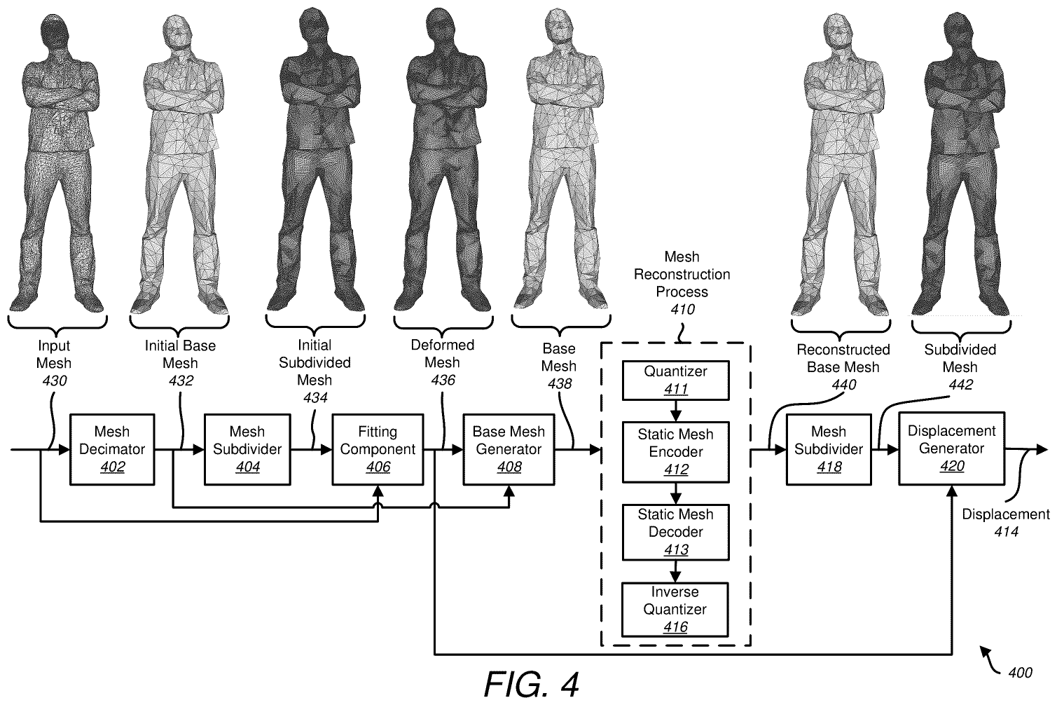

In some examples, a mesh sequence (e.g., mesh sequence 108) may include a set of mesh frames (e.g., mesh frames 124) that may be individually encoded and decoded. As will be further described below with respect to FIG. 4, a base mesh 252 may be determined (e.g., generated) from a mesh frame (e.g., an input mesh) through a decimation process. In the decimation process, the mesh topology of the mesh frame may be reduced to determine the base mesh (e.g., a decimated mesh or decimated base mesh). A mesh encoder 204 may encode base mesh 252, whose geometry information (e.g., vertices) may be quantized by quantizer 202, to generate a base mesh bitstream 254. In some examples, base mesh encoder 204 may be an existing encoder such as Draco or Edgebreaker.

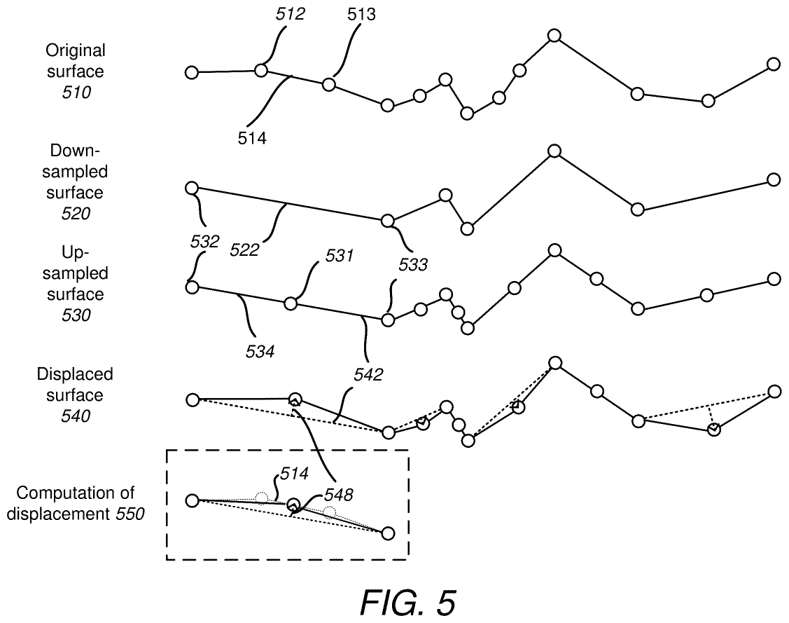

Displacement generator 208 may generate displacements for vertices of the mesh frame based on base mesh 252, as will be further explained below with respect to FIGS. 4 and 5. In some examples, the displacements are determined based on a reconstructed base mesh 256. Reconstructed base mesh 256 may be determined (e.g., output or generated) by mesh decoder 206 that decodes the encoded base mesh (e.g., in base mesh bitstream 254) determined (e.g., output or generated) by mesh encoder 204. Displacement generator 208 may subdivide reconstructed base mesh 256 using a subdivision scheme (e.g., subdivision algorithm) to determine a subdivided mesh (e.g., a subdivided base mesh). Displacement 258 may be determined based on fitting the subdivided mesh to an original input mesh surface. For example, displacement 258 for a vertex in the mesh frame may include displacement information (e.g., a displacement vector) that indicates a displacement from the position of the corresponding vertex in the subdivided mesh to the position of the vertex in the mesh frame.

Displacement 258 may be transformed by wavelet transformer 210 to generate wavelet coefficients (e.g., transformation coefficients) representing the displacement information and that may be more efficiently encoded (and subsequently decoded). The wavelet coefficients may be quantized by quantizer 212 and packed (e.g., arranged) by image packer 214 into a picture (e.g., one or more images or picture frames) to be encoded by video encoder 216. Mux 218 may combine (e.g., multiplex) the displacement bitstream 260 output by video encoder 216 together with base mesh bitstream 254 to form bitstream 266.

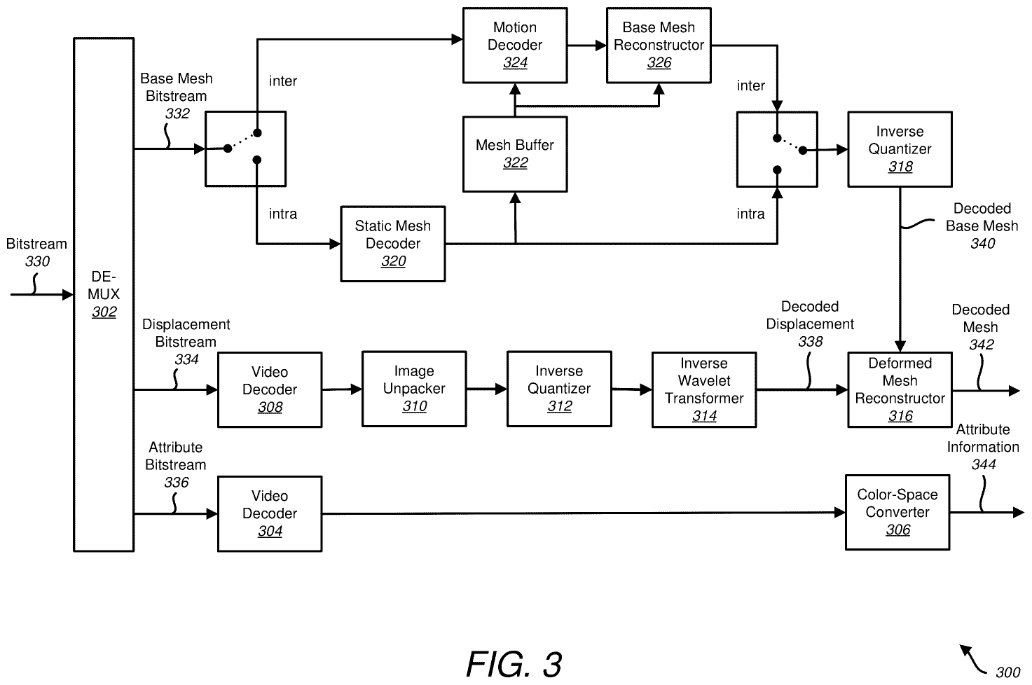

Attribute information 262 (e.g., color, texture, etc.) of the mesh frame may be encoded separately from the geometry information of the mesh frame described above. In some examples, attribute information 262 of the mesh frame may be represented (e.g., stored) by an attribute map (e.g., texture map) that associates each vertex of the mesh frame with corresponding attributes information of that vertex. Attribute transfer 232 may re-parameterize attribute information 262 in the attribute map based on reconstructed mesh determined (e.g., generated or output) from mesh reconstruction components 225. Mesh reconstruction components 225 perform inverse or decoding functions and may be the same or similar components in a decoder (e.g., decoder 300 of FIG. 3). For example, inverse quantizer 228 may inverse quantize reconstructed base mesh 256 to determine (e.g., generate or output) reconstructed base mesh 268. Video decoder 226, image unpacker 224, inverse quantizer 222, and inverse wavelet transformer 220 may perform the inverse functions as that of video encoder 216, image packer 214, quantizer 212, and wavelet transformer 210, respectively. Accordingly, reconstructed displacement 270, corresponding to displacement 258, may be generated from applying video decoder 226, image unpacker 224, inverse quantizer 222, and inverse wavelet transformer 220 in that order. Deformed mesh reconstructor 230 may determine the reconstructed mesh, corresponding to the input mesh frame, based on reconstructed base mesh 268 and reconstructed displacement 270. In some examples, the reconstructed mesh may be the same decoded mesh determined from the decoder based on decoding base mesh bitstream 254 and displacement bitstream 260.

Attribute information of the re-parameterized attribute map may be packed in images (e.g., 2D images or picture frames) by padding component 234. Padding component 234 may fill (e.g., pad) portions of the images that do not contain attribute information. In some examples, color-space converter 236 may translate (e.g., convert) the representation of color (e.g., an example of attribute information 262) from a first format to a second format (e.g., from RGB444 to YUV420) to achieve improved rate-distortion (RD) performance when encoding the attribute maps. In an example, color-space converter 236 may also perform chroma subsampling to further increase encoding performance. Finally, video encoder 240 encodes the images (e.g., pictures frames) representing attribute information 262 of the mesh frame to determine (e.g., generate or output) attribute bitstream 264 multiplexed by mux 218 into bitstream 266. In some examples, video encoder 240 may be an existing 2D video compression encoder such as an HEVC encoder or a VVC encoder.

FIG. 2B illustrates a block diagram of an example encoder 200B for inter encoding a 3D mesh, according to some embodiments. For example, an encoder (e.g., encoder 114) may comprise encoder 200B. As shown in FIG. 2B, encoder 200B comprises many of the same components as encoder 200A. In contrast to encoder 200A, encoder 200B does not include mesh encoder 204 and mesh decoder 206, which correspond to coders for static 3D meshes. Instead, encoder 200B comprises a motion encoder 242, a motion decoder 244, and a base mesh reconstructor 246. Motion encoder 242 may determine a motion field (e.g., one or more motion vectors (MVs)) that, when applied to a reconstructed quantized reference base mesh 243, best approximates base mesh 252.

The determined motion field may be encoded in bitstream 266 as motion bitstream 272. In some examples, the motion field (e.g., a motion vector in the x, y, and z directions) may be entropy coded as a codeword (e.g., for each directional component) resulting from a coding scheme such as a unary, a Golomb code (e.g., Exp-Golomb code), a Rice code, or a combination thereof. In some examples, the codeword may be arithmetically coded, e.g., using CABAC. A prefix part of the codeword may be context coded and a suffix part of the coded may be bypass coded. In some examples, a sign bit for each directional component of the motion vector may be coded separately.

In some examples, motion bitstream 272 may further include indication of the selected reconstructed quantized reference base mesh 243.

In some examples, motion bitstream 272 may be decoded by motion decoder 244 and used by base mesh reconstructor 246 to generate reconstructed quantized base mesh 256. For example, base mesh reconstructor 246 may apply the decoded motion field to reconstructed quantized reference base mesh 243 to determine (e.g., generate) reconstructed quantized base mesh 256.

In some examples, a reconstructed quantized reference base mesh m′(j) associated with a reference mesh frame with index j may be used to predict the base mesh m(i) associated with the current frame with index i. Base meshes m(i) and m(j) may comprise the same: number of vertices, connectivity, texture coordinates, and texture connectivity. The positions of vertices may differ between base meshes m(i) and m(j).

In some examples, the motion field f(i) may be computed by considering the quantized version of m(i) and the reconstructed quantized base mesh m′(j). Base mesh m′(j) may have a different number of vertices than m(j) (e.g., vertices may have been merged or removed). Therefore, the encoder may track the transformation applied to m(j) to determine (e.g., generate or obtain) m′(j) and applies it to m(i). This transformation may enable a 1-to-1 correspondence between vertices of base mesh m′(j) and the transformed and quantized version of base mesh m(i), denoted as m\hat{ }*(i). The motion field f(i) may be computed by subtracting the quantized positions Pos(i,v) of the vertex v of m\hat{ }*(i) from the positions Pos(i,v) of the vertex v of m′(j) as follows: f(i,v)=Pos(j,v)−Pos(i,v). The motion field may be further predicted by using the connectivity information of base mesh m′(j) and the prediction residuals may be entropy encoded.

In some examples, since the motion field compression process may be lossy, a reconstructed motion field denoted as f′(i) may be computed by applying the motion decoder component. A reconstructed quantized base mesh m′(i) may then be computed by adding the motion field to the positions of vertices in base mesh m′(j). To better exploit temporal correlation in the displacement and attribute map videos, inter prediction may be enabled in the video encoder.

In some embodiments, an encoder (e.g., encoder 114) may comprise encoder 200A and encoder 200B.

FIG. 3 illustrates a diagram showing an example decoder 300. Bitstream 330, which may correspond to bitstream 266 in FIGS. 2A and 2B and may be received in a binary file, may be demultiplexed by de-mux 302 to separate bitstream 330 into base mesh bitstream 332, displacement bitstream 334, and attribute bitstream 336 carrying base mesh geometry information, displacement geometry information, and attribute information, respectively. Attribute bitstream 336 may include one or more attribute map sub-streams for each attribute type.

In some examples, for inter decoding, the bitstream is de-multiplexed into separate sub-streams, including: a motion sub-stream, a displacement sub-stream for positions and potentially for each vertex attribute, zero or more attribute map sub-streams, and an atlas sub-stream containing patch information in the same manner as in V3C/V-PCC.

In some examples, base mesh bitstream 332 may be decoded in an intra mode or an inter mode. In the intra mode, static mesh decoder 320 may decode base mesh bitstream 332 (e.g., to generate reconstructed base mesh m′(i)) that is then inverse quantized by inverse quantizer 318 to determine (e.g., generate or output) decoded base mesh 340 (e.g., reconstructed quantized base mesh m″(i)). In some examples, static mesh decoder 320 may correspond to mesh decoder 206 of FIG. 2A.

In some examples, in the inter mode, base mesh bitstream 332 may include motion field information that is decoded by motion decoder 324. In some examples, motion decoder 324 may correspond to motion decoder 244 of FIG. 2B. For example, motion decoder 324 may entropy decode base mesh bitstream 332 to determine motion field information. In the inter mode, base mesh bitstream 332 may indicate a previous base mesh (e.g., reference base mesh m′(j)) decoded by static mesh decoder 320 and stored (e.g., buffered) in mesh buffer 322. Base mesh reconstructor 326 may generate a quantized reconstructed base mesh m′(i) by applying the decoded motion field (output by motion decoder 324) to the previously decoded (e.g., reconstructed) base mesh m′(j) stored in mesh buffer 322. In some examples, base mesh reconstructor 326 may correspond to base mesh reconstructor 246 of FIG. 2B. The quantized reconstructed base mesh may be inverse quantized by inverse quantizer 318 to determine (e.g., generate or output) decoded base mesh 340 (e.g., reconstructed base mesh m″ (i)). In some examples, decoded base mesh 340 may be the same as reconstructed base mesh 268 in FIGS. 2A and 2B.

In some examples, decoder 300 includes video decoder 308, image unpacker 310, inverse quantizer, and inverse wavelet transformer 314 that determines (e.g., generates) decoded displacement 338 from displacement bitstream 334. Video decoder 308, image unpacker 310, inverse quantizer, and inverse wavelet transformer 314 correspond to video decoder 226, image unpacker 224, inverse quantizer 222, and inverse wavelet transformer 220, respectively, and perform the same or similar operations. For example, the picture frames (e.g., images) received in displacement bitstream 334 may be decoded by video decoder 308, the displacement information may be unpacked by image unpacker 310 from the decoded image, inverse quantized by inverse quantizer 312 to determined inverse quantized wavelet coefficients representing encoded displacement information. Then, the unquantized wavelet coefficients may be inverse transformed by inverse wavelet transformer 314 to determine decoded displacement d″(i). In other words decoded displacement 338 (e.g., decoded displacement field d″(i)) may be the same as reconstructed displacement 270 in FIGS. 2A and 2B.

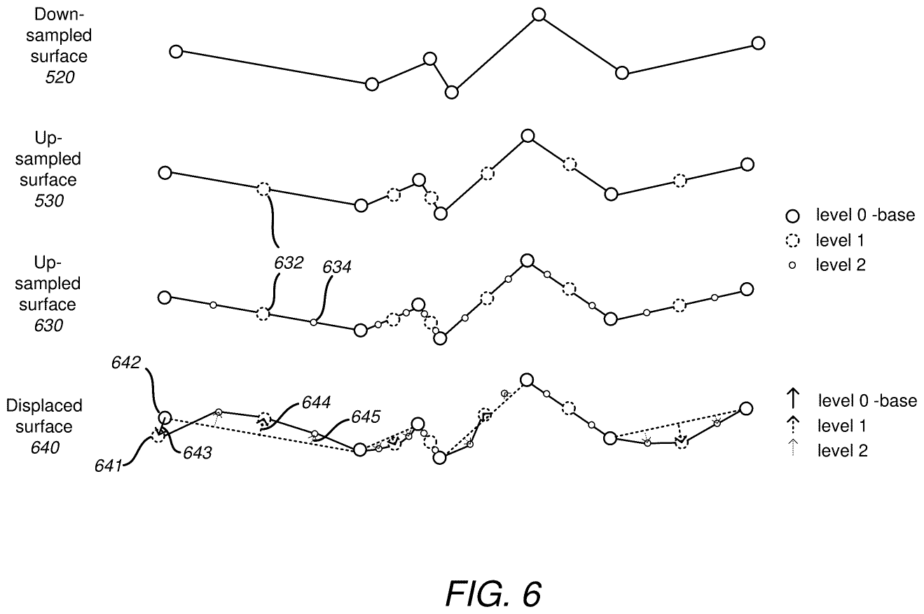

Deformed mesh reconstructor 316, which corresponds to deformed mesh reconstructor 230, may determine (e.g., generate or output) decoded mesh 342 (M″(i)) based on decoded displacement 338 and decoded base mesh 340. For example, deformed mesh reconstructor 316 may combine (e.g., add) decoded displacement 338 to a subdivided decoded mesh 340 to determine decoded mesh 342. Specifically, decoded displacement 338 may include a respective reconstructed displacement vector corresponding to each vertex of a subdivided mesh (e.g., identically generated as subdivided mesh 442 by encoder in FIG. 4) generated from decoded base mesh 340. For example, the decoder may apply a subdivision scheme to subdivide decoded base mesh 340 to generate the subdivided mesh, as described with respect to FIG. 6.

In some examples, decoder 300 includes video decoder 304 that decodes attribute bitstream 336 comprising encoded attribute information represented (e.g., stored) in 2D images (or picture frames) to determined attribute information 344 (e.g., decoded attribute information or reconstructed attribute information). In some examples, video decoder 304 may be an existing 2D video compression decoder such as an HEVC decoder or a VVC decoder. Decoder 300 may include a color-space converter 306, which may revert the color format transformation performed by color-space converter 236 in FIGS. 2A and 2B.

FIG. 4 is a diagram 400 showing an example process (e.g., a pre-processing operations) for generating displacements 414 of an input mesh 430 (e.g., an input 3D mesh frame) to be encoded, according to some embodiments. In some examples, displacements 414 may correspond to displacement 258 shown in FIG. 2A and FIG. 2B.

In diagram 400, a mesh decimator 402 determines (e.g., generates or outputs) an initial base mesh 432 based on (e.g., using) input mesh 430. In some examples, the initial base mesh 432 may be determined (e.g., generated) from the input mesh 432 through a decimation process. In the decimation process, the mesh topology of the mesh frame may be reduced to determine the initial base mesh (which may be referred to as a decimated mesh or decimated base mesh). As will be illustrated in FIG. 5, the decimation process may involve a down sampling process to remove vertices from the input mesh 432 so that a small portion (e.g., 6% or less) of the vertices in the input mesh 430 may remain in the initial base mesh 432.

Mesh subdivider 404 applies a subdivision scheme to generate initial subdivided mesh 434. As will be discussed in more detail with regard to FIG. 5, the subdivision scheme may involve upsampling the initial base mesh 432 to add more vertices to the 3D mesh based on the topology and shape of the original mesh to generate the initial subdivided mesh 434.

Fitting component 406 may fit the initial subdivided mesh to determine a deformed mesh 436 that may more closely approximate the surface of input mesh 430. As will be discussed in more detail with respect to FIG. 5, the fitting may be performed by moving vertices of the initial subdivided mesh 434 towards the surfaces of the input mesh 430 so that the subdivided mesh 434 can be used to approximate the input mesh 430. In some implementations, the fitting is performed by moving each vertex of the initial subdivided mesh 434 along the normal direction of the vertex until the vertex intersects with a surface of the input mesh 430. The resulting mesh is the deformed mesh 436. The normal direction may be indicated by a vertex normal at the vertex.

Base mesh generator 408 may perform another fitting process to generate a base mesh 438 from the initial base mesh 432. For example, the base mesh generator 408 may deform the initial base mesh 432 according to the deformed mesh 436 so that the initial base mesh 432 is close to the deformed mesh 436. In some implementations, the fitting process may be performed in a similar manner to the fitting component 406. For example, the base mesh generator 408 may move each of the vertices in the initial base mesh 432 along its normal direction (e.g., based on the vertex normal at each vertex) until the vertex reaches a surface of the deformed mesh 436. The output of this process is the base mesh 438.

Base mesh 438 may be output to a mesh reconstruction process 410 to generate a reconstructed base mesh 440. Reconstructed base mesh 440 may be subdivided by mesh subdivider 418 and the subdivided mesh 442 may be input to displacement generator 420 to generate (e.g., determine or output) displacement 414, as further described below in FIG. 5. In some examples, mesh subdivider 418 may apply the same subdivision scheme as that applied by mesh subdivider 404. In these examples, vertices in the subdivided mesh 442 have a one-to-one correspondence with the vertices in the deformed mesh 436. As such, the displacement generator 420 may generate the displacements 414 by calculating the difference between each vertex of the subdivided mesh 442 and the corresponding vertex of the deformed mesh 436. In some implementations, the difference may be projected onto a normal direction of the associated vertex and the resulting vector is the displacement 414. In this way, only the sign and magnitude of the displacement 414 need to be encoded in the bitstream, thereby increasing the coding efficiency. In addition, because the base mesh 438 has been fitted toward the deformed mesh 436, the displacements 414 between the deformed mesh 436 and the subdivided mesh 442 (generated from the reconstructed base mesh 440) will have small magnitudes, which further reduces the payload and increases the coding efficiency.

In some examples, one advantage of applying the subdivision process is to allow for more efficient compression, while offering a faithful approximation of the original input mesh 430 (e.g., surface or curve of the original input mesh 430). The compression efficiency may be obtained because the base mesh (e.g., decimated mesh) has a lower number of vertices compared to the number of vertices of input mesh 430 and thus requires a fewer number of bits to be encoded and transmitted. Additionally, the subdivided mesh may be automatically generated by the decoder once the base mesh has been decoded without any information needed from the encoder other than a subdivision scheme (e.g., subdivision algorithm) and parameters for the subdivision (e.g., a subdivision iteration count). The reconstructed mesh may be determined by decoding displacement information (e.g., displacement vectors) associated with vertices of the subdivided mesh (e.g., subdivided curves/surfaces of the base mesh). Not only does the subdivision process allow for spatial/quality scalability, but also the displacements may be efficiently coded using wavelet transforms (e.g., wavelet decomposition), which further increases compression performance.

In some embodiments, mesh reconstruction process 410 includes components for encoding and then decoding base mesh 438. FIG. 4 shows an example for the intra mode, in which mesh reconstruction process 410 may include quantizer 411, static mesh encoder 412, static mesh encoder 412, static mesh decoder 413, and inverse quantizer 416, which may perform the same or similar operations as quantizer 202, mesh encoder 204, mesh decoder 206, and inverse quantizer 228, respectively, from FIG. 2A. In the inter mode, mesh reconstruction process 410 may include quantizer 202, motion encoder 242, motion decoder 244, base mesh reconstructor 246, and inverse quantizer 228.

FIG. 5 illustrates an example process for approximating and encoding a geometry of a 3D mesh, according to some embodiments. For illustrative purposes, the 3D mesh is shown as 2D curves. An original surface 510 of the 3D mesh (e.g., a mesh frame) includes vertices (e.g., points) and edges that connect neighboring vertices. For example, point 512 and point 513 are connected by an edge corresponding to surface 514.

In some examples, a decimation process (e.g., a down-sampling process or a decimation/down-sampling scheme) may be applied to an original surface 510 of the original mesh to generate a down-sampled surface 520 of a decimated (or down-sampled) mesh. In the context of mesh compression, decimation refers to the process of reducing the number of vertices in a mesh while preserving its overall shape and topology. For example, original mesh surface 510 is decimated into a surface 520 with fewer samples (e.g., vertices and edges) but still retains the main features and shape of the original mesh surface 510. This down-sampled surface 520 may correspond to a surface of the base mesh (e.g., a decimated mesh).

In some examples, after the decimation process, a subdivision process (e.g., subdivision scheme or subdivision algorithm) may be applied to down-sampled surface 520 to generate an up-sampled surface 530 with more samples (e.g., vertices and edges). Up-sampled surface 530 may be part of the subdivided mesh (e.g., subdivided base mesh) resulting from subdividing down-sampled surface 520 corresponding to a base mesh.

Subdivision is a process that is commonly used after decimation in mesh compression to improve the visual quality of the compressed mesh. The subdivision process involves adding new vertices and faces to the mesh based on the topology and shape of the original mesh. In some examples, the subdivision process starts by taking the reduced mesh that was generated by the decimation process and iteratively adding new vertices and edges. For example, the subdivision process may comprise dividing each edge (or face) of the reduced/decimated mesh into shorter edges (or smaller faces) and creating new vertices at the points of division. These new vertices are then connected to form new faces (e.g., triangles, quadrilaterals, or another polygon). By applying subdivision after decimation process, a higher level of compression can be achieved without significant loss of visual fidelity. Various subdivision schemes may be used such as, e.g., mid-point, Catmull-Clark subdivision, Butterfly subdivision, Loop subdivision, etc.

For example, FIG. 5 illustrates an example of the mid-point subdivision scheme applied to down-sampled surface 520 to generate up-sampled surface 530. In this scheme, each subdivision iteration subdivides each triangle into four sub-triangles. New vertices are introduced in the middle of each edge. The subdivision process may be applied independently to the geometry and to the texture coordinates since the connectivity for the geometry and for the texture coordinates are usually different. The subdivision scheme computes the position Pos(v₁₂) of a newly introduced vertex v₁₂ at the center of an edge (v₁, v₂), as follows:

$$Pos ( {v}_{12} ) = \frac{1}{2} ( Pos ( {v}_{1} ) + Pos ( {v}_{2} ) ) , \qquad ( 1 )$$

where Pos(v₁) and Pos(v₂) are the positions of the vertices v₁ and v₂. In some examples, the same process may be used to compute the texture coordinates of the newly created vertex. For normal vectors, a normalization step may be applied as follows:

$$N ( {v}_{12} ) = \frac{N ( {v}_{1} ) + N ( {v}_{2} )}{‖ N ( {v}_{1} ) + N ( {v}_{2} ) ‖} , \qquad ( 2 )$$

N(v₁₂), N(v₁), and N(v₂) are the normal vectors associated with the vertices v₁₂, v₁, and v₂, respectively. ∥x∥ is the norm2 of the vector x.

Using the mid-point subdivision scheme, as shown in up-sampled surface 530, point 531 may be generated as the mid-point of edge 522 which is an edge connecting point 532 and point 533. Point 531 may be added as a new vertex. Edge 534 and edge 542 are also added to connect the added new vertex corresponding to point 531. In some examples, the original edge 522 may be replaced by new edges 534 and 542.

In some examples, down-sampled surface 520 may be iteratively subdivided to generate up-sampled surface 530. For example, a first subdivided mesh resulting from a first iteration of subdivision applied to down-sampled surface 520 may be further subdivided according to the subdivision scheme to generate a second subdivided mesh, etc. In some examples, a number of iterations corresponding to levels of subdivision may be predetermined. In other examples, an encoder may indicate the number of iterations to a decoder, which may similarly generate a subdivided mesh, as further described above.

In some examples, the subdivision scheme is applied identically at the encoder and the decoder to generate the same up-sampled surface 530 from the same down-sampled surface 520. For example, the encoder may signal (e.g., encode) information representing vertices of down-sampled surface 520, which may be the base mesh, in a bitstream. The decoder may decode the information from the bitstream to obtain the vertices of down-sampled surface 520.

In some embodiments, at the encoder, the subdivided mesh may be deformed towards (e.g., approximates) the original mesh to determine (e.g., get or obtain) a prediction of the original mesh having original surface 510. The points on the subdivided mesh may be moved along a computed normal orientation/direction until it reaches an original surface 510 of the original mesh. For example, each point (also referred to as vertex) may be associated with a vertex normal computed from a normalized average of face normals (also referred to as surface normals) of faces containing that point. The vertex normal is a directional vertex indicating the normal direction of the point. The distance between the intersected point on the original surface 510 and the subdivided point may be computed as a displacement (e.g., a displacement vector). For example, point 531 may be moved towards the original surface 510 along a computed normal orientation of surface (e.g., represented by edge 542). When point 531 intersects with surface 514 of the original surface 510 (of original/input mesh), a displacement vector 548 can be computed. Displacement vector 548 applied to point 531 may result in displaced surface 540, which may better approximate original surface 510. In some examples, displacement information (e.g., displacement vector 548) for vertices of the subdivided mesh (e.g., up-sampled surface 530 of subdivided mesh) may be encoded and transmitted in displacement bitstream 260 shown in examples encoders of FIGS. 2A and 2B.

In some embodiments, displacements d(i) (e.g., a displacement field or displacement vectors) may be computed and/or stored based on local coordinates or global coordinates. For example, a global coordinate system is a system of reference that is used to define the position and orientation of objects or points in a 3D space. It provides a fixed frame of reference that is independent of the objects or points being described. The origin of the global coordinate system may be defined as the point where the three axes intersect. Any point in 3D space can be located by specifying its position relative to the origin along the three axes using Cartesian coordinates (x, y, z). For example, the displacements may be defined in the same cartesian coordinate system as the input or original mesh. Accordingly, a displacement may comprise three components (in the x, y, and z directions).

In a local coordinate system, a normal, a tangent, and/or a binormal vector (which are mutually perpendicular) may be determined that defines a local basis for the 3D space to represent the orientation and position of an object in space relative to a reference frame. In some examples, displacement field d(i) may be transformed from the canonical coordinate system to the local coordinate system, e.g., defined by a normal to the subdivided mesh at each vertex. In some examples, using the local coordinate system may enable further compression of tangential components of the displacements compared to the normal component. For example, the displacements may be signaled as a scalar value (e.g., including a sign and a magnitude) which may be used to derive a displacement vector based on the normal at the vertex. A normal vector at the vertex may be computed based on a normalized average of face normals (or surface normals) of faces (of the 3D mesh) containing that vertex. Accordingly, using local coordinate system, displacements need not be signaled as three components corresponding to the directions of the canonical coordinate system.

In some embodiments, a decoder (e.g., decoder 300 of FIG. 3) may receive and decode a base mesh corresponding to (e.g., having) down-sampled surface 520. Similar to the encoder, the decoder may apply a subdivision scheme to determine a subdivided mesh having up-sampled surface 530 generated from down-sampled surface 520. The decoder may receive and decode displacement information including displacement vector 548 and determine a decoded mesh (e.g., reconstructed mesh) based on the subdivided mesh (corresponding to up-sampled surface 530) and the decoded displacement information.

FIG. 6 illustrates an example of vertices of a subdivided mesh (e.g., a subdivided base mesh) corresponding to multiple levels of detail (LODs), according to some embodiments. As described above with respect to FIG. 5, the subdivision process (e.g., subdivision scheme) may be an iterative process, in which a mesh can be subdivided multiple times and a hierarchical data structure is generated containing multiple levels. Each level of the hierarchical data structure may include different numbers of data samples (e.g., vertices and edges in mesh) representing (e.g., forming) different density/resolution (e.g., LODs). For example, a down-sampled surface 520 (of a decimated mesh) can be subdivided into up-sampled surface 530 after a first iteration of subdivision. Down-sampled surface 520 may represent a decimated mesh, which is also referred to as a base mesh (e.g., reconstructed base mesh 256 or reconstructed base mesh 268 of FIGS. 2A-B, decoded base mesh 340 of FIG. 3, or reconstructed base mesh 440 of FIG. 4).

Up-sampled surface 530 may be further subdivided into up-sampled surface 630. In this case, vertices of the mesh with down-sampled surface 520 may be considered as being in or associated with LOD0. Vertices, such as vertex 632, generated in up-sampled surface 530 after a first iteration of subdivision may be at LOD1. Vertices, such as vertex 634, generated in up-sampled surface 630 after another iteration of subdivision may be at LOD2, etc. In some examples, an LOD0 may refer to the vertices resulting from decimation of an input (e.g., original) mesh resulting in a base mesh with (e.g., having) down-sampled surface 520.

In some examples, at the encoder, the computation of displacement in different LODs follows the same mechanism as described above with respect to FIG. 5. In some examples, a displacement vector 643 may be computed from a vertex 642, at LOD0 of up-sampled surface 630, to a vertex 641 with a position in the original surface 510 (e.g., surface of original input mesh 430 or deformed mesh 436 of FIG. 4). The displacement vectors 644 and 645 of corresponding vertices 632 and 634 from LOD1 and LOD 2, respectively, may be similarly calculated. Accordingly, in some examples, a number of iterations of subdivision may correspond to a number of LODs and one of the iterations may correspond to one LOD of the LODs. The encoder may signal transformed wavelet coefficients in a bitstream to represent the computed displacements. A displaced surface 640 is of a deformed mesh resulting from applying the displacements to vertices of up-sampled surface 630. This deformed mesh may be the 3D mesh reconstructed at the decoder.

In some examples, at the decoder, the displacements for vertices of up-sampled surface 630 may be reconstructed from the bitstream based on inverse transforming the transformed wavelet coefficients. Then, the decoder may apply each reconstructed displacement to a respective vertex of up-sampled surface 630 to obtain displace surface 640 of the reconstructed 3D mesh. For example, displacement vector 643 may be reconstructed and applied to a respective vertex 642 of up-sampled surface 630 to obtain vertex 641 of the reconstructed 3D mesh.

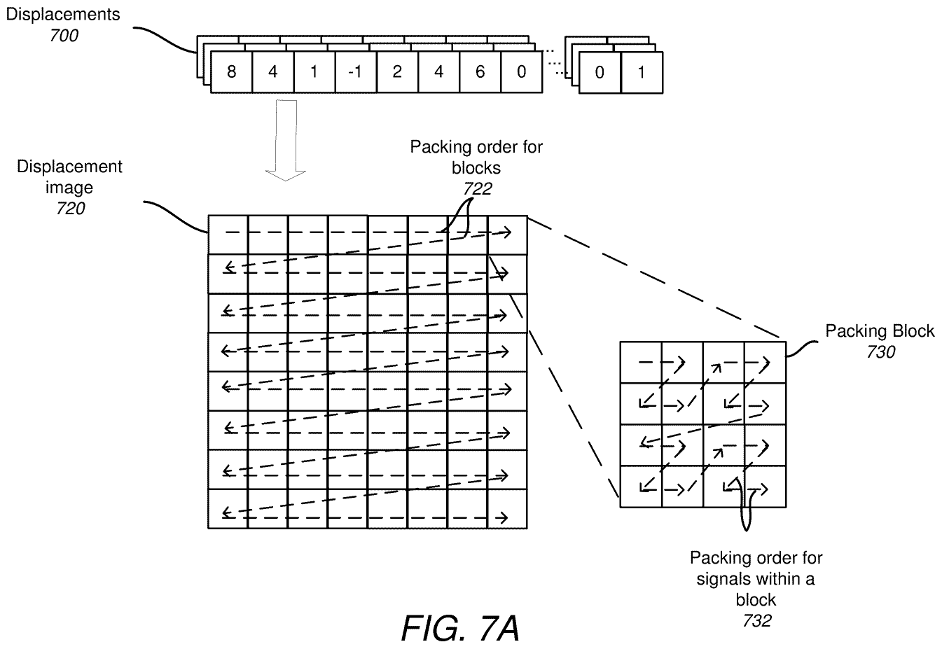

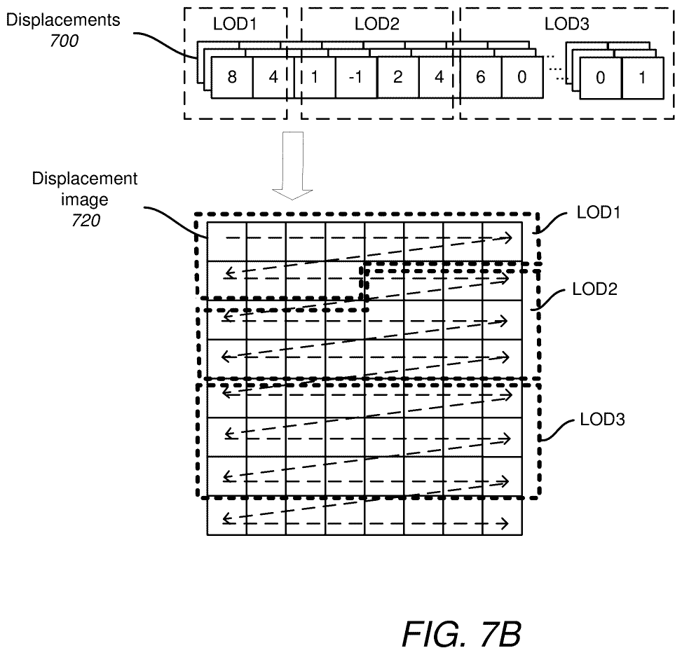

FIG. 7A illustrates an example of an image 720 (e.g., picture or a picture frame) packed with displacements 700 (e.g., displacement fields or vectors) using a packing method (e.g., a packing scheme or a packing algorithm), according to some embodiments. Specifically, displacements 700 may be generated, as described above with respect to FIG. 5 and FIG. 6, or received to be packed into 2D images. In some examples, a displacement can be a 3D vector containing the values for the three components of the distance. For example, a delta x value represents the shift in x-axis from a point A to a point B in a Cartesian coordinate system. In some examples, a displacement vector may be represented by less than three components, e.g., by one or two components. For example, when a local coordinate system is used to store the displacement value, one component with the highest significance may be stored as being representative of the displacement and the other components may be discarded.

In some examples, as will be further described below, a displacement value may be transformed into other signal domains for achieving better compression. For example, a displacement can be wavelet transformed and be decomposed into and represented as wavelet coefficients (e.g., coefficient values or transform coefficients). In these examples, displacements 700 that are packed in image 720 may comprise the resulting wavelet coefficients (e.g., transform coefficients), which may be more efficiently compressed than the un-transformed displacement values. At the decoder side, a decoder may decode displacements 700 as wavelet coefficients and may apply an inverse wavelet decomposition process to reconstruct the original displacement values.

In some examples, one or more of displacements 700 may be quantized by the encoder before being packed into displacement image 720. In some examples, one or more displacements may be quantized before being wavelet transformed, after being wavelet transformed, or quantized before and after being wavelet transformed. For example, FIG. 7A shows quantized wavelet transform values 8, 4, 1, −1, etc. in displacements 700. At the decoder side, the decoder may perform inverse quantization to revert the quantization process performed by the encoder.

In general, quantization in signal processing may be the process of mapping input values from a larger set to output values in a smaller set. It is often used in data compression to reduce the amount, the precision, or the resolution of the data into a more compact representation. However, this reduction can lead to a loss of information and introduce compression artifacts. The choice of quantization parameters, such as the number of quantization levels, is a trade-off between the desired level of precision and the resulting data size. There are many different quantization techniques, such as uniform quantization, non-uniform quantization, and adaptive quantization that may be selected/enabled/applied. They can be employed depending on the specific requirements of the application.

In some examples, wavelet coefficients (e.g., displacement coefficients) may be adaptively quantized according to LODs. As explained above, a mesh may be iteratively subdivided to generate a hierarchical data structure comprising multiple LODs. In this example, each vertex and its associated displacement belong to the same level of hierarchy in the LOD structure, e.g., an LOD corresponding to a subdivision iteration in which that vertex was generated. In some examples, a vertex at each LOD may be quantized according to corresponding quantization parameters that specify different levels of intensity/precision of the signal to be quantized. For example, wavelet coefficients in LOD 3 may have a quantization parameter with, e.g., 42 and wavelet coefficients in LOD 0 may have a different, smaller quantization parameter of 28 to preserve more detail information in LOD 0.

In some examples, displacements 700 may be packed onto the pixels in a displacement image 720 with a width W and a height H. In an example, a size of displacement image 720 (e.g., W multiplied by H) may be greater or equal to the number of components in displacements 700 to ensure all displacement information may be packed. In some examples, displacement image 720 may be further partitioned into smaller regions (e.g., squares) referred to as a packing block 730. In an example, the length of packing block 730 may be an integer multiple of 2.

The displacements 700 (e.g., displacement signals represented by quantized wavelet coefficients) may be packed into a packing block 730 according to a packing order 732. Each packing block 730 may be packed (e.g., arranged or stored) in displacement image 720 according to a packing order 722. Once all the displacements 700 are packed, the empty pixels in image 720 may be padded with neighboring pixel values for improved compression. In the example shown in FIG. 7A, packing order 722 for blocks may be a raster order and a packing order 732 for displacements within packing block 730 may be a Z-order. However, it should be understood that other packing schemes both for blocks and displacements within blocks may be used. In some embodiments, a packing scheme for the blocks and/or within the blocks may be predetermined. In some embodiments, the packing scheme may be signaled by the encoder in the bitstream per patch, patch group, tile, image, or sequence of images.

In some examples, packing order 732 may follow a space-filling curve, which specifics a traversal in space in a continuous, non-repeating way. Some examples of space-filling curve algorithms (e.g., schemes) include Z-order curve, Hilbert Curve, Peano Curve, Moore Curve, Sierpinski Curve, Dragon Curve, etc. Space-filling curves have been used in image packing techniques to efficiently store and retrieve images in a way that maximizes storage space and minimizes retrieval time. Space-filling curves are well-suited to this task because they can provide a one-dimensional representation of a two-dimensional image. One common image packing technique that uses space-filling curves is called the Z-order or Morton order. The Z-order curve is constructed by interleaving the binary representations of the x and y coordinates of each pixel in an image. This creates a one-dimensional representation of the image that can be stored in a linear array. To use the Z-order curve for image packing, the image is first divided into small blocks, typically 8×8 or 16×16 pixels in size. Each block is then encoded using the Z-order curve and stored in a linear array. When the image needs to be retrieved, the blocks are decoded using the inverse Z-order curve and reassembled into the original image.

In some examples, once packed, displacement image 720 may be encoded and decoded using a conventional 2D video codec.

FIG. 7B illustrates an example of displacement image 720, according to some embodiments. As shown, displacements 700 packed in displacement image 720 may be ordered according to their LODs. For example, displacement coefficients (e.g., quantized wavelet coefficients) may be ordered from a lowest LOD to a highest LOD. In other words, a wavelet coefficient representing a displacement for a vertex at a first LOD may be packed(e.g., arranged and stored in displacement image 720) according to the first LOD. For example, displacements 700 may be packed from a lowest LOD to a highest LOD. Higher LODs represent a higher density of vertices and corresponds to more displacements compared to lower LODs. The portion of displacement image 720 not in any LOD may be a padded portion.

In some examples, displacements may be packed in inverse order from highest LOD to lowest LOD. In an example, the encoder may signal whether displacements are packed from lowest to highest LOD or from highest to lowest LOD.

In some examples, a wavelet transform may be applied to displacement values to generate wavelet coefficients (e.g., displacement coefficients) representing displacement signals that may be more easily compressed. Wavelet transforms are commonly used in signal processing to decompose a signal into a set of wavelets, which are small wave-like functions allowing them to capture localized features in the signal. The result of the wavelet transform is a set of coefficients that represent the contribution of each wavelet at different scales and positions in the signal. It is useful for detecting and localizing transient features in a signal and is generally used for signal analysis and data compression such as image, video, and audio compression.

Taking a 2D image as an example, a wavelet transform is used to decompose an image (signals) into two discrete components, known as predictions (e.g., also referred to as approximations) and details. The decomposed signals are further divided into a high frequency component (details) and a low frequency component (approximations/predictions) by passing through two filters, high and low pass filters. In the example of the 2D image, two filtering stages, a horizontal and a vertical filtering, are applied to the image signals. A down-sampling step is also required after each filtering stage on the decomposed components to obtain the wavelet coefficients resulting in four sub-signals in each decomposition level. The high frequency component corresponds to rapid changes or sharp transitions in the signal, such as an edge or a line in the image. On the other hand, the low frequency component refers to global characteristics of the signal. Depending on the application, different filtering and compression can be achieved. There are various types of wavelets such as Haar, Daubechies, Symlets, etc., each with different properties such as frequency resolution, time localization, etc.

In signal processing, a lifting scheme is a technique for both designing wavelets and performing the discrete wavelet transform (DWT). It is an alternative approach to the traditional filter bank implementation of the DWT that offers several advantages in terms of computational efficiency and flexibility. It decomposes the signal using a series of lifting steps such that the input signal, e.g., representing displacements for 3D meshes, may be converted to displacement coefficients in-place. In the lifting scheme, a series of lifting operations (e.g. lifting steps) may be performed. Each lifting operation involves a prediction step (e.g., prediction operation) and an update step (e.g., update operation). These lifting operations may be applied iteratively to obtain the wavelet coefficients.

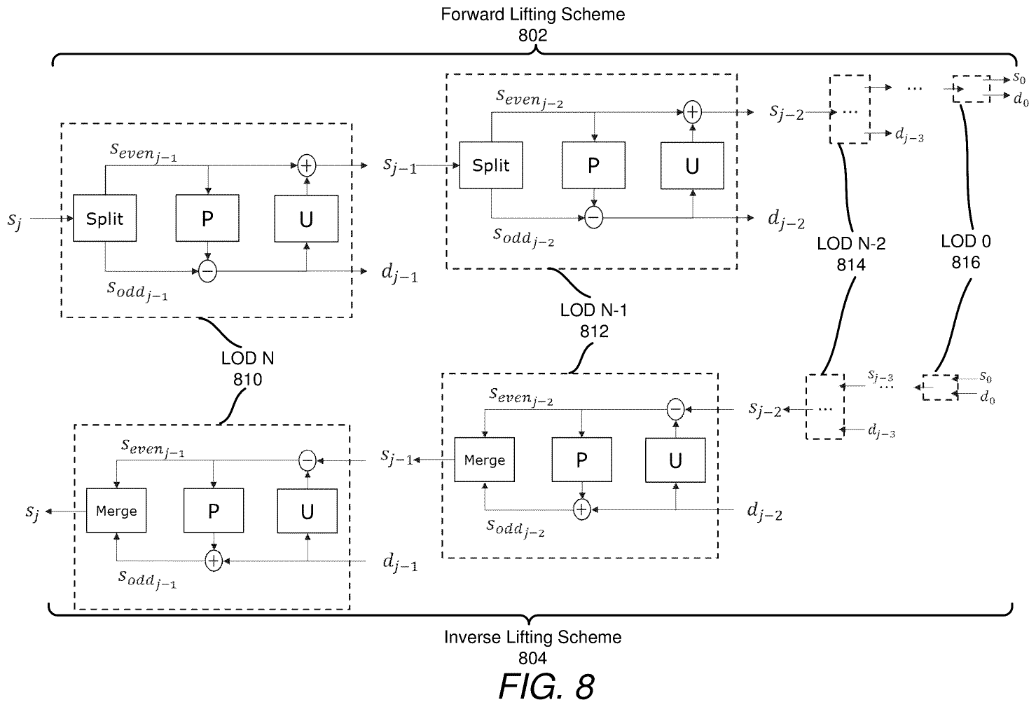

FIG. 8 illustrates an example of a lifting scheme for representing displacement information of a 3D mesh as wavelet coefficients, according to some embodiments. The lifting scheme may refer to a forward lifting scheme 802 and/or an inverse lifting scheme 804. The lifting scheme comprises a plurality of lifting operations, which may be iteratively performed. Each lifting operation may include a prediction operation (e.g., prediction step) and an update operation (e.g., an update step). An encoder may perform (e.g., apply) forward lifting scheme 802 to determine (e.g., derive, generate, or obtain) wavelet coefficients representing displacement information. A decoder may perform (e.g., apply) inverse lifting scheme 804 to reverse the operations of forward lifting scheme 802 to determine (e.g., derive, generate, or obtain) the displacement information from wavelet coefficients decoded from a bitstream. The decoded displacement information may include displacement values (e.g., displacement vectors) corresponding to vertices of a 3D mesh frame, which may be used by the decoder to generate a decoded mesh (e.g., a reconstructed mesh).

Forward lifting scheme 802 comprises a plurality of iterations corresponding to a plurality of LODs, e.g., shown as LOD_{N} 810, LOD_{N-1} 812, LOD_{N-2} 814, and LOD₀ 816. Each iteration of forward lifting scheme 802 (e.g., four iterations are shown as four dotted boxes corresponding to LODs 810-816) includes a splitting operation (e.g., a splitting step shown as a “Split” component), a prediction operation (e.g., a prediction step shown as a “P” component), and an update operation (e.g., an update step shown as a “U” component).

The splitting operation separates (or splits) signal sⱼ (j≥1) into two non-overlapping signals: the even samples denoted by sₑᵥₑₙ_{ₖ} (k∈[0, j−1]) and the odd samples denoted by s_{odd}_{ₖ}. Signal sⱼ represents the displacement values (e.g., displacement signals) determined for vertices of the 3D mesh frame. For example, a displacement value comprises a displacement field(e.g., a displacement vector), which may be one, two, or three components, as explained above. In each lifting operation iteration, the odd samples s_{odd}_{ₖ} include the displacement coefficients of vertices at an LOD corresponding to the iteration. For each odd sample of the odd samples s_{odd}_{ₖ}, the even samples sₑᵥₑₙ_{ₖ} may include the two displacement coefficients of the two vertices, of the 3D mesh frame, from which the vertex corresponding to the odd sample was generated during a mesh subdivision or down-sampling process, as explained above with respect to FIG. 6. Since vertices at the LOD are generated from vertices at lower LODs, the two vertices of the 3D mesh frame are at LODs that are lower than the LOD of the lifting operation iteration.

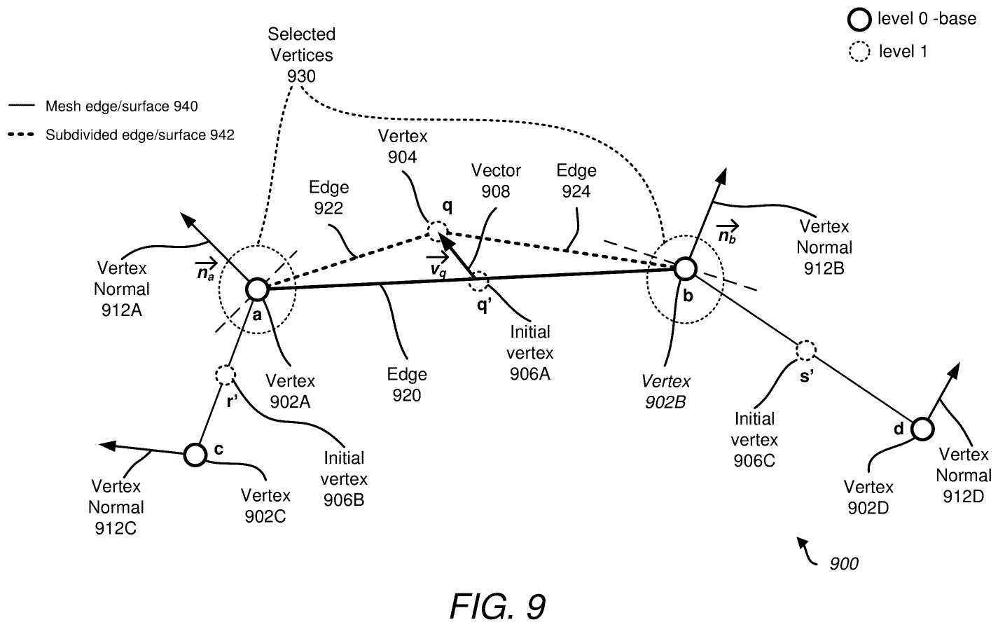

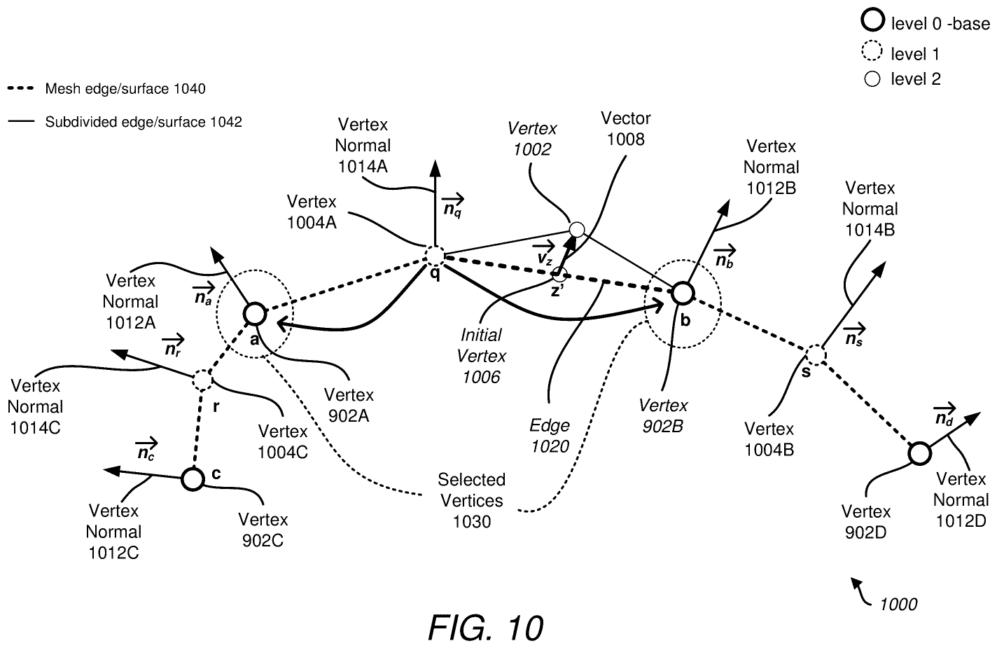

The prediction operation determines (e.g., computes) a prediction for the odd samples based on the even samples. For example, the prediction may be subtracted from the odd samples (e.g., shown as circles with negative signs) to generate a prediction error, e.g., error signal dₖ (k ∈[0, j−1]). Forward lifting scheme 802 also includes an update operation that recalibrates the low-frequency signals (e.g., corresponding to signals at lower LODs) with some of the energy removed during the subsampling. In the case of classical lifting, this is used to prepare the even signals for the next prediction operation in the next iteration of forward lifting scheme 802. For example, the update operation updates (e.g., prepares) the even signals based on the error signal dk representing a difference between odd sample s_{odd}_{ₖ} and a corresponding predicted odd sample. In some examples, the update operation may update the even signal sₑᵥₑₙ_{ₖ} based on adding the prediction error dk to the even signal sₑᵥₑₙ_{ₖ} (e.g., shown as circle with positive signs). In some examples, the prediction error dₖ may be adjusted by an update weight, as will be further described below in FIGS. 9 and 10, and the even signal may be updated based on the adjusted prediction error.

In some embodiments, a decoder performs inverse lifting scheme 804 to reverse the operations of forward lifting scheme 802. For example, whereas forward lifting scheme 802 comprises lifting operations that are iteratively performed from higher LODs (e.g., LOD_{N} 810) to lower LODs (e.g., LOD₀ 816), inverse lifting scheme 804 comprises lifting operations that are iteratively performed from lower LODs (e.g., LOD₀ 816) to higher LODs (e.g., LOD_{N} 810). Each iteration of inverse lifting scheme 804 (e.g., four iterations are shown as four dotted boxes corresponding to LODs 810-816) includes an update operation (e.g., an update step shown as a “U” component), a prediction operation (e.g., a prediction step shown as a “P” component), and a merge operation (e.g., a merge step shown as a “Merge” component).

Different from forward lifting scheme 802, an update operation, in each lifting operation of inverse lifting scheme 804, may update the even signals sₖ (e.g., corresponding to transformed displacement coefficients) by subtracting prediction error dₖ (corresponding to odd signals at the LOD corresponding to the lifting operation iteration) from the even samples to determine the updated even samples sₑᵥₑₙ_{ₖ}. In some examples, the prediction error dₖ may be adjusted by an update weight, and the even samples may be updated based on the adjusted prediction error. For example, the update weight corresponding to an LOD of an odd signal may be determined. For example, the update weight may be indicated by an indication signaled in the bitstream by an encoder and obtained from the bitstream by the decoder. A prediction operation, in each lifting operation of inverse lifting scheme 804, may determine a reconstructed predicted odd sample s_{odd}_{ₖ} based on the updated even samples sₑᵥₑₙ_{ₖ}. For example, the prediction operation may determine an average of two updated even samples sₑᵥₑₙ_{ₖ} to determine a prediction of a reconstructed odd sample. In some examples, two updated even samples sₑᵥₑₙ_{ₖ} may be combined as a weighted average using respective weights. Each lifting operation of inverse lifting scheme 804 combines (e.g., shown as circles with positive signs) the reconstructed predicted odd sample with the prediction error dₖ to determine (e.g., generate or obtain) a displacement signal s_{odd}_{ₖ} corresponding to a displacement value determined at the encoder. In other words, the plurality of iterations of inverse lifting scheme 804 converts the wavelet coefficients (displacement coefficients), generated by the encoder and representing displacement information, into displacement values that may be used to reconstruct the (3D) mesh frame. Further, to revert the splitting operation of forward lifting scheme 802, each lifting operation of inverse lifting scheme 804 includes a merge operation that merges (e.g., orders or combines as a sequence of signals or values) the updated even samples sₑᵥₑₙ_{ₖ} with the reconstructed odd sample s_{odd}_{ₖ}.

Note that the value j in FIG. 8 corresponds to a number of iterations for the lifting operations which varies depending on the specific requirement of the application for 3D meshes. For example, the number of levels in LOD defined by the mesh decimation process may be used for the lifting operations. In some examples, a mid-point subdivision scheme may be used in the mesh decimation process. In these examples, since each vertex in a higher LOD level is a generated mid-point of an edge defined by two vertices in lower LOD levels, the signal (e.g., displacement value or its wavelet coefficient representation) associated with that vertex may be decomposed and represented by two sub-signals (e.g., displacement values or their wavelet coefficient representations) which belong to the corresponding two vertices. For example, a vertex v in LOD₁ (e.g., an LOD of level 1) may be the mid-point of the edge defined by two vertices v1 and v2 in LOD₀ (e.g., an LOD of level 0). In this example, the displacement associated with v can be wavelet transformed by using the lifting scheme. For an odd signal s_{odd}_{ₖ} corresponding to vertex v (e.g., the signal being the displacement signal or its wavelet coefficient representation), the even samples sₑᵥₑₙ_{ₖ} determined for odd signal s_{odd}_{ₖ} may correspond to vertices v1 and v2 (e.g., the signals being displacement signals or their wavelet coefficient representations) from which vertex v was generated.

In the lifting scheme, prediction weight and update weight are the values used to modify the input data during the prediction and update steps, respectively. The prediction weight may be a scalar value or a set of coefficients that define the linear combination of the neighboring signals used for prediction while the update weight determines the contribution of the prediction error to the final updated value. For example, the prediction may be determined from two input even samples based on a prediction weight equal to one half, which effectively averages signal values of the two input even samples. The prediction and update weights are often selected to satisfy certain properties or conditions to achieve desired characteristics in the transformed data. For example, in lossless lifting schemes, the weights may be selected to ensure perfect reconstruction of the original signal. In lossy lifting schemes, the weights may be selected to achieve specific frequency response characteristics or to minimize distortion based on the compression or denoising requirements.

In some implementations of the lifting scheme, the prediction weight and the update weight may be determined (e.g., selected), applied to displacements for vertices of a 3D mesh (e.g., each mesh frame of a sequence of mesh frames), such as to balance accuracy and properties resulting from the wavelet transforms corresponding to the displacements. As explained above, prediction operations of each iteration of the inverse lifting scheme may be dependent on (e.g., impacted by) updated signals inputs to the prediction operation. However, the update weight may be a value (e.g., ⅛, ¼, or 1/16, etc.) selected to be uniformly applied to wavelet coefficients corresponding (e.g., representing) the displacements. Due to characteristics and geometry of the mesh frame, characteristics at each LOD may not be the same. Therefore, applying the same update weight may results in reduced compression for displacements (e.g., displacement signals) for vertices at certain LODs.

In some embodiments, adaptive update weights in the lifting scheme are applied to displacements for vertices of 3D meshes (e.g., mesh frames of a sequence of mesh frames of a 3D mesh). For example, an update weight for each wavelet coefficient may be determined based on an LOD associated with that wavelet coefficient. As explained above, the lifting scheme may include a plurality of lifting operations corresponding to a plurality of LODs in the 3D mesh (e.g., mesh frame). For a forward lifting scheme, each iteration of the lifting operation may update (e.g., lift) a sequence of displacement signals (e.g., displacement values or corresponding wavelet coefficients representing the displacement values) from a higher LOD (e.g., denser vertices) to one or more lower LODs (e.g., sparser vertices) and accumulate the prediction towards vertices at the lowest LOD (e.g., vertices of the base mesh). Similarly, for an inverse lifting scheme, each iteration of the lifting operation may update (e.g., lift) a sequence of displacement signals (e.g., displacement values or corresponding wavelet coefficients representing the displacement values) from lower LOD (e.g., sparser vertices) to higher LODs (e.g., denser vertices). Since the update weight determines the amount of contribution of the prediction error to the final updated value, adapting uniform weight values to consider the impact of different LOD levels may result in more accurate predicting signals across different LOD levels. In some examples, lower LODs may be associated with smaller update weights and higher LODs may be associated with larger update weights. In some examples, lower LODs may be associated with larger update weights and higher LODs may be associated with smaller update weights.

In some embodiments, a decoder obtains from a bitstream transformed coefficients representing displacements of vertices of a three-dimensional (3D) mesh. After inverse quantizing the obtained transformed coefficients, the decoder applies a lifting wavelet transform scheme, such as that described above in FIG. 8, to obtain inverse-transformed wavelet coefficients representing the reconstructed displacements (e.g., reconstructed displacement vectors). As described with respect to FIGS. 5-6, the decoder and encoder may identically generate a subdivided mesh from a base mesh (e.g., down-sampled surface 520 of FIGS. 5-6). The decoder may reconstruct the 3D mesh by adding the displacements to respective vertices (e.g., positions of vertices) of the subdivided mesh.

In existing technologies, the subdivided mesh may be generated by applying a mid-point subdivision scheme to the base mesh, as described with respect to FIGS. 4-6. The base mesh, with many fewer vertices, was derived from an original 3D mesh as being representative of the 3D mesh. However, the additional vertices generated by the mid-point subdivision scheme are not necessarily close to or representative of the surface of the original 3D mesh (or a deformed mesh representative of the original 3D mesh). This is because the mid-point subdivision scheme subdivides the faces and edges of the base mesh into additional vertices, edges, and faces that are part of the surfaces of the base mesh.

In some implementations, a normal-based subdivision scheme may be used instead to subdivide the base mesh. In this normal-based subdivision scheme, each vertex generated by subdividing an edge of an input mesh (e.g., the base mesh or a subdivided mesh) may be generated by refining the mid-point point according to vertex normals of vertices forming the edge. By doing so, each iteration of subdividing the base mesh and subsequent subdivided base meshes may generate new vertices that are not on the same plane as the surface of the base mesh. Accordingly, the final subdivided mesh may be closer to the original 3D mesh (or a deformed mesh representative of the original 3D mesh) and result in smaller displacements being signaled in the bitstream.

FIG. 9 illustrates a diagram 900 of an example normal-based subdivision scheme, according to some embodiments. The normal-based subdivision scheme may be performed identically at the encoder and the decoder such that the same subdivided mesh may be generated from a base mesh.

Diagram 900 shows vertices 902A-D of a mesh edge/surface 940. Vertices 902A-D may be at a first LOD (e.g., level 0) and correspond, e.g., to vertices of a base mesh. It should be noted that for illustration purposes, the mesh surface 940 is represented as lines in diagram 900. Diagram also shows initial vertices 906A-C that would have been generated by a mid-point subdivision scheme in which each edges of mesh surface 940 are subdivided to generate edges and surfaces of a subdivided mesh at a next LOD (e.g., level 1). Subdividing the edges also results in subdivided surfaces of mesh edge/surface 940.

In some embodiments, vertex normals 912A-D are computed for respective vertices 902A-D of mesh edge/surface 940. In some examples, a vertex normal of a vertex may be determined based on a normalized average of face normals (e.g., surface normals) of faces (e.g., surfaces) containing that vertex. For example, a face normal of a face of mesh surface 940 may be determined based on a cross product of two edges forming the face.

As shown, the normal-based subdivision scheme may subdivide edge 920 of mesh surface 940 to generate a vertex 904 and subdivided edges 922-924 of subdivided edge/surface 942 at the next LOD. In some examples, an initial vertex 906A (q′) along edge 920 may be adjusted (e.g., displaced) by a vector 908 (e.g., refinement vector \vec{v_{q}}) to determine vertex 904 (q). For example, vertex 904 may result from initial vertex 906A added to vector 908. In some examples, initial vertex 906A may be a midpoint point along edge 920 resulting from averaging vertices 902A and 902B.

In some examples, vector 908 may be generated based on obtaining (e.g., selecting) vertices 930 forming edge 920. For example, vector 908 may be generated based on vertex normals 912A-B of vertices 902A-B (e.g., labeled vertices a and b) forming edge 920.

In some examples, vector 908 (\vec{v_{q}}) may be a linear combination of vertex normals 912A-B (\vec{nₐ} and \vec{n_{b}}). For example, each vertex normal of the vertex normals 912A-B may be weighted by a respective normal weight (dₐ and d_{b}) that is based on the edge and the vertex normal. For example, vertex 904 (q) may be determined according to equation (3) as follows:

$$q = {q}^{′} + {w}_{i} \cdot ( {d}_{a} \cdot \vec{{n}_{a}} + {d}_{b} \cdot \vec{{n}_{b}} ) \qquad ( 3 )$$

In an example, initial vertex q′ may be determined as follows:

$$\frac{1}{2} ( v + p ) .$$

In some embodiments, a weight (dᵢ where i represents a specific vertex) for a vertex normal (n_{ι}) may be determined (e.g., derived) as a dot product between the subdivided edge 920 and the vertex normal. For example, the weights for vertex normals 912A-B (\vec{nₐ} and \vec{n_{b}}) may be determined according to equations (4) and (5) as follows:

$${d}_{a} = \frac{1}{2} ( a - b ) \cdot \vec{{n}_{a}} \qquad ( 4 )$$

$${d}_{b} = \frac{1}{2} ( b - a ) \cdot \vec{{n}_{b}} \qquad ( 5 )$$

In some examples, for deriving a normal weight for a vertex, the edge may be converted to a vector defined from a further vertex (forming the edge) to a closer vertex (forming the edge) with respect to the vertex. Accordingly, the normal weights may be based on the length of edge 920 and angles between edge 920 and each of the vertex normals 912A-B.

In some embodiments, the linear combination of equation (3) further includes a vector weight wᵢ that weights vector 908. The vector weight may control a smoothness of the subdivision surface to reduce the adjustment. In some examples, vector weight wᵢ may be based on an LOD (level i) of, e.g., vertex 904. For example, the vector weight wᵢ may be determined according to equation (6) as follows, where T may represent the highest LOD level:

$${w}_{i} = pow ( 2 , i - T ) \qquad ( 6 )$$

FIG. 10 illustrates a diagram 1000 of an example normal-based subdivision scheme, using extended connectivity information, according to some embodiments. For example, diagram 1000 may show applying the normal-based subdivision scheme to the resulting subdivided edge/surface 942 of FIG. 9. For example, diagram 1000 shows mesh edge/surface 1040 resulting from a previous iteration of applying a normal-based subdivision scheme. Mesh edge/surface 1040 may include subdivided edge/surface 942 of FIG. 9.

As shown, mesh edge/surface 1040 includes vertices 902A-D (at LOD 0) and vertices 1004A-C(at LOD 1) resulting from the previous iteration of applying the normal-base subdivision scheme. In some examples, vertex normals of each vertex of mesh edge/surface 1040 may be recomputed to determine vertex normals 1012A-D for vertices 902A-D, respectively, and vertex normals 1014A-C for vertices 1004A-C, respectively.

In some examples, edge 1020 may be subdivided to generate a vertex at a next LOD. By applying the normal-based subdivision scheme of FIG. 9, only vertex normals 1014A-B corresponding to vertices 1004A and vertex 902B, forming edge 1020, would be considered in adjusting initial vertex 1006. However, considering only vertex normals 1014A-B may result in overfitting an adjustment of initial vertex 1006 or result in deviation from characteristics of the original 3D mesh. In some embodiments, accuracy of adjustment of initial vertex 1006 may be increased by considering extended connectivity information of vertices 1004A and 902B forming edge 1020.

Accordingly, embodiments of enhancing the normal-based subdivision scheme may relate to subdividing an edge of a mesh by using vertex normals of extended connectivity information of a pair of vertices forming that edge.

For example, subdividing edge 1020 may including adjusting initial vertex 1006 by vector 1008 to determine vertex 1002 of subdivided edge/surface 1042 at the next LOD (e.g., LOD 2). In some embodiments, vector 1008 may be determined as a linear combination of vertex normals of vertices used to generate at least one vertex of vertices 1004A and 902B forming edge 1020. In some examples, these vertex normals may be used instead of or in addition to vertex normals 1014A and 1012B of vertices 1004A and 902B.

For example, vertex 1004A was generated, during a previous iteration of subdivision, from vertex 902A and vertex 902B at one or more LODs lower than an LOD (e.g., LOD 1) of vertex 1004A. For example, vertex 902B may be at the lowest LOD and may correspond to a vertex in a base mesh and was not derived from vertices of previous LODs. Accordingly, vertex normals 1012A and vertex normal 1012B of selected vertices 1030 may be used in a linear combination to determine vector 1008 in equation (7) as follows:

$$z = {z}^{′} + {w}_{i} \cdot ( 0.5 * {d}_{a} \cdot \vec{{n}_{a}} + 0.5 * {d}_{b} \cdot \vec{{n}_{b}} + 1 * {d}_{b} ) \qquad ( 7 )$$

A normal weight of each of vertex normals 1012A-B may be determined based on edge 1020 and the respective vertex normal. For example, the normal weight may be a dot product of the vertex normal and a vector between a farther vertex of edge 1020 to a closer vertex of edge 1020 with respect to vertex 1004A associated with vertices 902A-B corresponding to vertex normals 1012A-B. For example, the normal weight for vertex normals 1012A-B may be determined according to equations (8) and (9) as follows:

$${d}_{a} = \frac{1}{2} ( q - b ) \cdot \vec{{n}_{a}} \qquad ( 8 )$$

$${d}_{b} = \frac{1}{2} ( q - b ) \cdot \vec{{n}_{b}} \qquad ( 9 )$$

Similar to FIG. 9, initial vertex 1006 may be determined based on a point along edge 1020. For example, initial vertex 1006 may be determined as a midpoint point of edge 1020.

In some embodiments, each of normal weights (da and db) may be further weighted according to a scaling weight associated with an LOD of the vertex corresponding to the normal weight.

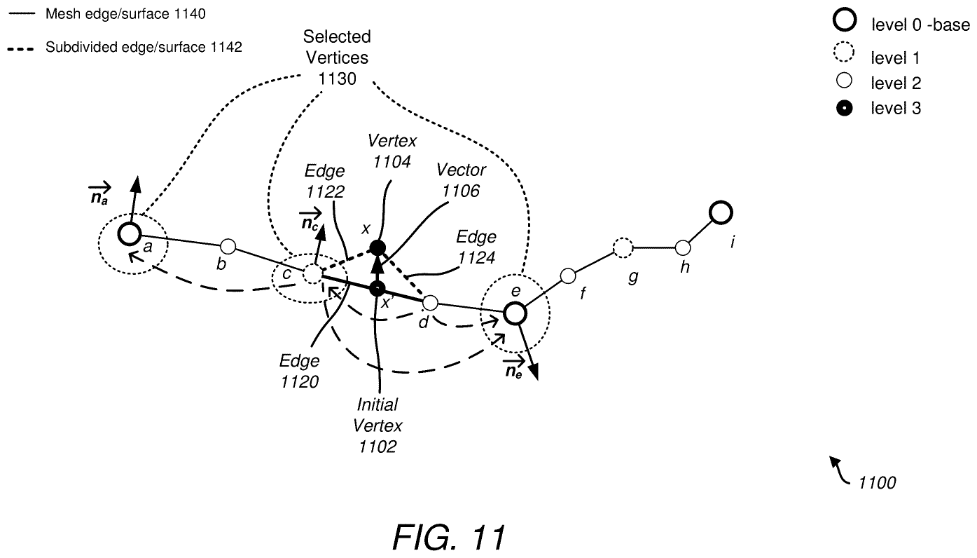

FIG. 11 illustrates a diagram 1100 of an example normal-based subdivision scheme, according to some embodiments. For example, diagram 1100 shows a normal-based subdivision scheme, with extended connectivity information, further applied to a subdivided mesh at LOD 2 resulting from the subdivision process described with respect to FIG. 10. As shown in FIG. 11, the subdivided mesh at LOD 2 may be represented by mesh edge/surface 1140 including vertices a-i. Further, a vertex normal may be recomputed for each vertex of mesh edge/surface 1140.

For example, the normal-based subdivision scheme may subdivide edge 1120 of mesh edge/surface 1140 to generate a vertex 1104 at the next LOD (e.g., LOD 3) and subdivided edges 1122 and 1124 of subdivided edge/surface 1142. In some examples, vertex 1104 may be determined based on adjusting initial vertex 1102 by vector 1106. For example, initial vertex 1102 may be a midpoint point along edge 1120 between vertices c and d forming edge 1120 to be subdivided.

In some embodiments, vector 1106 may be determined as a linear combination of vertex normals of a first pair of vertices and a second pair of vertices used to generate vertices c and d, respectively. For example, vertex c was previously generated, in a previous subdivision iteration, by a first pair of vertices a and e at one or more lower LODs than an LOD of vertex c. Likewise, vertex d was previously generated, in a previous subdivision iteration, by a second pair of vertices c and e at one or more lower LODs than an LOD of vertex d. Accordingly, vertex normals from selected vertices 1130 used to generate vertices c and d may be selected in determining the linear combination. By considering extended connectivity information, including vertex normals of selected vertices 1130, in generating vertex 1104, instead of or in addition to vertex normals of only vertices c and d forming edge 1120, the position of vertex 1104 may be more likely to be closer to a position of the 3D mesh (or corresponding deformed mesh representing the 3D mesh). Additionally, by considering this extended connectivity information, overfitting using only vertex normals of vertices c and d may be avoided.

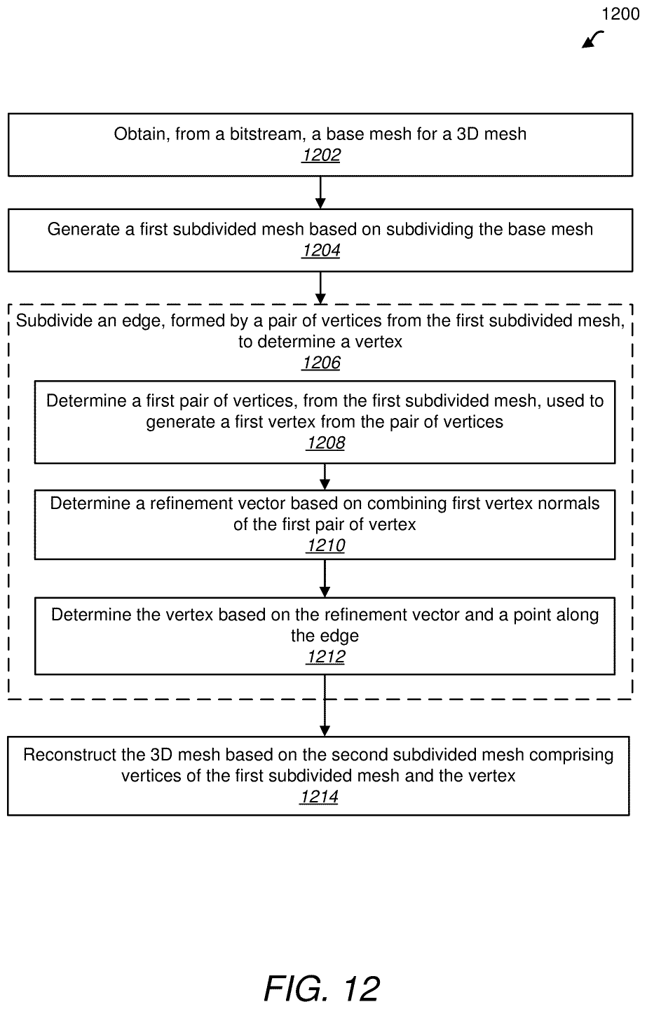

FIG. 12 illustrates a flowchart of a method 1200 for performing normal-based subdivision for reconstructing (e.g., decoding) a 3D mesh, according to some embodiments. In some examples, method 1300 may be performed by a decoder (e.g., decoder 120 of FIG. 1 or decoder 300 of FIG. 3). The following descriptions of various steps may refer to operations performed by deformed mesh reconstructor 316 of FIG. 3 and described with respect to FIGS. 10-11.

At block 1202, a decoder obtains, from a bitstream, a base mesh for a 3D mesh.

At block 1204, the decoder generates a first subdivided mesh based on subdividing the bash mesh. For example, the first subdivided mesh may be the result of one or more iterations of a subdivision scheme applied to the base mesh. The subdivision scheme may be a normal-based subdivision scheme, as described with respect to FIGS. 10-11.

In some embodiments, the decoder obtains, from the bitstream, a mode indication of a subdivision scheme from a plurality of subdivision schemes. The subdivision scheme may be associated with normal-based subdivision.

In some examples, the plurality of subdivision schemes may include a first subdivision scheme that subdivides each edge of a mesh according to vertex normals of a pair of vertices forming each edge.

In some examples, the plurality of subdivision schemes may include a second subdivision scheme that subdivides each edge of the mesh according to vertex normals of vertices forming at least one vertex of the pair of vertices forming each edge.

In some examples, the plurality of subdivision schemes may include a midpoint subdivision scheme.

At block 1206, the decoder subdivides an edge, formed by a pair of vertices from the first subdivided mesh, to determine a vertex. The process of subdividing the edge may include blocks 1208-1212.

At block 1208, the decoder determines a first pair of vertices, from the first subdivided mesh, used to generate a first vertex from the pair of vertices.

At block 1210, the decoder determines a refinement vector based on combining first vertex normals of the first pair of vertex.

In some embodiments, the determination of the refinement vector further includes determining a second pair of vertices, from the first subdivided mesh, used to generate a second vertex from the pair of vertices. Then, the refinement vector is determined based on combining the first vertex normals and second vertex normals of the second pair of vertices.

In some examples, the refinement vector is determined further based on combining with vertex normals of the pair of vertices.

In some examples, the refinement vector may be determined based on a linear combination of the first vertex normals, with each vertex normal of the first vertex normals being weighted by a normal weight determined using the edge and the each vertex normal. For example, the normal weight may be determined based on a dot product of the vertex normal and the edge. The pair of vertices includes the first vertex and a second vertex, and the dot product is between the vertex normal and a vector defined from the first vertex to the second vertex.

In some examples, when the linear combination further includes combining the first vertex normals and the second vertex normals of the second pair of vertices. In these examples, each second vertex normal of the second vertex normals is weighted by a second normal weight determined using the edge and the each second vertex normal. For example, the second normal weight is determined based on a dot product of the vertex normal and a vector defined from the second vertex to the first vertex.

In some embodiments, the refinement vector (e.g., represented by any of the linear combinations described above) may be weighted by a vector weight. For example, the vector weight may be based on a level of detail (LOD) of the vertex. In some examples, the decoder may obtain, from the bitstream, a vector weight for each LOD of a plurality of LODs of the 3D mesh. For example, the bitstream may include subdivision information encoding the vector weight for each LOD.

At block 1212, the decoder determines the vertex based on the refinement vector and a point along the edge. In some examples, the point may be a midpoint point of the edge. For example, the midpoint point may be determined based on averaging (the values) of the pair of vertices forming the edge.

In some examples, the vertex is determined based on adding the refinement vector to the point. For example, the refinement vector indicates a displacement from the point to a position of the vertex.

At block 1214, the decoder reconstructs the 3D mesh based on the second subdivided mesh comprising first vertices of the first subdivided mesh and the vertex.

In some examples, reconstructing the 3D mesh includes obtaining, from the bitstream, displacements of second vertices of the second subdivided mesh. Then, the 3D mesh may be reconstructed based on updating the second vertices with the displacements. For example, each vertex of the second vertices may be added to a respective displacement vector of the displacements to determine a reconstructed vertex of vertices of the reconstructed 3D mesh.

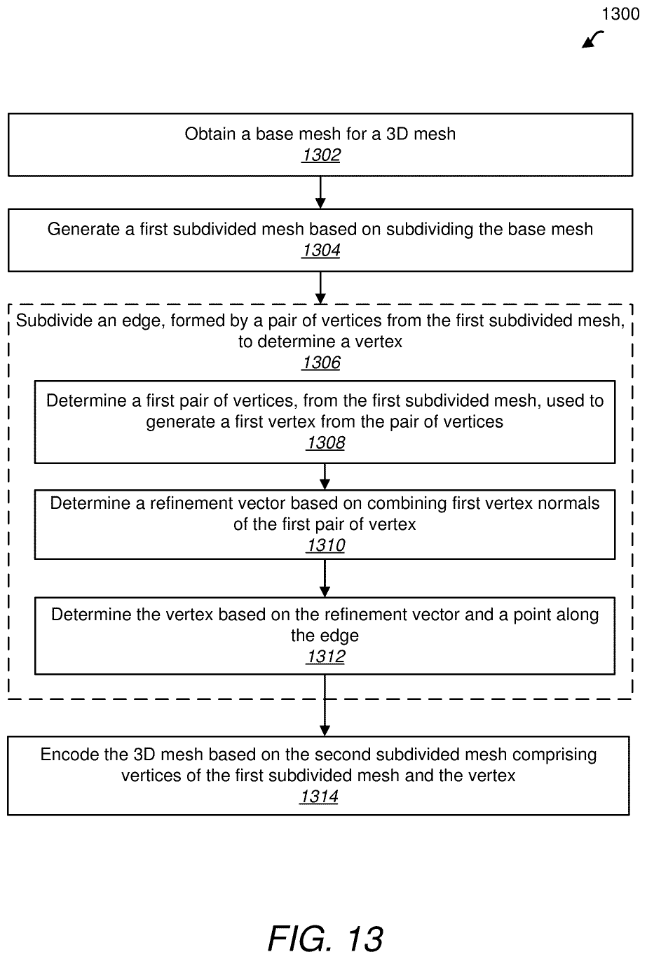

FIG. 13 illustrates a flowchart of a method 1300 for performing normal-based subdivision for encoding a 3D mesh, according to some embodiments. In some examples, method 1200 may be performed by an encoder (e.g., encoder 114 of FIG. 1, encoder 200A of FIG. 2A, or encoder 200B of FIG. 2B). The following descriptions of various steps may refer to operations performed by displacement generator 208 and/or deformed mesh reconstructor 230 of FIGS. 2A-B, and/or mesh subdivider 404 and/or mesh subdivider 418 of FIG. 4, and described with respect to FIGS. 10-11.

At block 1302, an encoder obtains a base mesh for a 3D mesh. In some examples, the encoder encodes vertices of the base mesh in a bitstream from which a decoder may obtain (e.g., decode) the vertices of the base mesh, e.g., at block 1202 of FIG. 12. In some examples, the encoder may apply a downsampling process to obtain the base mesh from the 3D mesh, as described with respect to FIG. 4.

At block 1304, the encoder generates a first subdivided mesh based on subdividing the bash mesh. Block 1304 may correspond to block 1204 of FIG. 12. For example, the first subdivided mesh may be the result of one or more iterations of a subdivision scheme applied to the base mesh. The subdivision scheme may be a normal-based subdivision scheme, as described with respect to FIGS. 10-11.

At block 1306, the encoder subdivides an edge, formed by a pair of vertices from the first subdivided mesh, to determine a vertex. The process of subdividing the edge may include blocks 1308-1312. Blocks 1308-1312 may correspond to blocks 1208-1212 of FIG. 12, respectively.

At block 1308, the encoder determines a first pair of vertices, from the first subdivided mesh, used to generate a first vertex from the pair of vertices.

At block 1310, the encoder determines a refinement vector based on combining first vertex normals of the first pair of vertex.

At block 1312, the encoder determines the vertex based on the refinement vector and a point along the edge.

As described above, the encoder and the decoder may apply the same subdivision scheme (e.g., a normal-based subdivision scheme) to the base mesh such that vertices of the subdivided mesh need not be signaled in the bitstream by the encoder. Accordingly, operations of blocks 1304-1312 performed by the encoder may be the same as those performed by the decoder and thus correspond to blocks 1204-1212 of FIG. 12, respectively.

At block 1314, the encoder encodes the 3D mesh based on the second subdivided mesh comprising vertices of the first subdivided mesh and the vertex.

In some examples, encoding the 3D mesh includes signaling, in the bitstream, displacements of the 3D mesh based on the second subdivided mesh including vertices of the first subdivided mesh and the vertex. For example, the encoder may determine the displacements for vertices of the second subdivided mesh based on differences between the second subdivided mesh and a representation of the 3D mesh, as described with respect to FIGS. 4-6. For example, the representation may be a fitted subdivided mesh (e.g., deformed mesh 436) generated from an original 3D mesh.

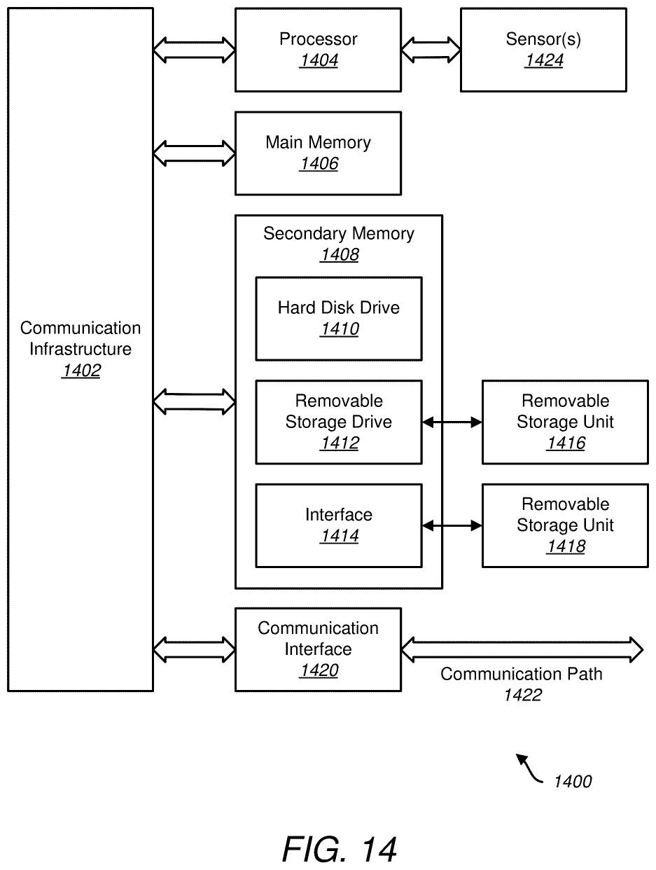

Embodiments of the present disclosure may be implemented in hardware using analog and/or digital circuits, in software, through the execution of instructions by one or more general purpose or special-purpose processors, or as a combination of hardware and software. Consequently, embodiments of the disclosure may be implemented in the environment of a computer system or other processing system. An example of such a computer system 1400 is shown in FIG. 14. Blocks depicted in the figures above, such as the blocks in FIG. 1, may execute on one or more computer systems 1400. Furthermore, each of the steps of the flowcharts depicted in this disclosure may be implemented on one or more computer systems 1400. When more than one computer system 1400 is used to implement embodiments of the present disclosure, the computer systems 1400 may be interconnected by one or more networks to form a cluster of computer systems that may act as a single pool of seamless resources. The interconnected computer systems 1400 may form a “cloud” of computers.

Computer system 1400 includes one or more processors, such as processor 1404. Processor 1404 may be, for example, a special purpose processor, general purpose processor, microprocessor, or digital signal processor. Processor 1404 may be connected to a communication infrastructure 1402 (for example, a bus or network). Computer system 1400 may also include a main memory 1406, such as random access memory (RAM), and may also include a secondary memory 1408.

Secondary memory 1408 may include, for example, a hard disk drive 1410 and/or a removable storage drive 1412, representing a magnetic tape drive, an optical disk drive, or the like. Removable storage drive 1412 may read from and/or write to a removable storage unit 1416 in a well-known manner. Removable storage unit 1416 represents a magnetic tape, optical disk, or the like, which is read by and written to by removable storage drive 1412. As will be appreciated by persons skilled in the relevant art(s), removable storage unit 1416 includes a computer usable storage medium having stored therein computer software and/or data.

In alternative implementations, secondary memory 1408 may include other similar means for allowing computer programs or other instructions to be loaded into computer system 1400. Such means may include, for example, a removable storage unit 1418 and an interface 1414. Examples of such means may include a program cartridge and cartridge interface (such as that found in video game devices), a removable memory chip (such as an EPROM or PROM) and associated socket, a thumb drive and USB port, and other removable storage units 1418 and interfaces 1414 which allow software and data to be transferred from removable storage unit 1418 to computer system 1400.

Computer system 1400 may also include a communications interface 1420. Communications interface 1420 allows software and data to be transferred between computer system 1400 and external devices. Examples of communications interface 1420 may include a modem, a network interface (such as an Ethernet card), a communications port, etc. Software and data transferred via communications interface 1420 are in the form of signals which may be electronic, electromagnetic, optical, or other signals capable of being received by communications interface 1420. These signals are provided to communications interface 1420 via a communications path 1422. Communications path 1422 carries signals and may be implemented using wire or cable, fiber optics, a phone line, a cellular phone link, an RF link, and other communications channels.

Computer system 1400 may also include one or more sensor(s) 1424. Sensor(s) 1424 may measure or detect one or more physical quantities and convert the measured or detected physical quantities into an electrical signal in digital and/or analog form. For example, sensor(s) 1424 may include an eye tracking sensor to track the eye movement of a user. Based on the eye movement of a user, a display of a 3D mesh may be updated. In another example, sensor(s) 1424 may include a head tracking sensor to the track the head movement of a user. Based on the head movement of a user, a display of a 3D mesh may be updated. In yet another example, sensor(s) 1424 may include a camera sensor for taking photographs and/or a 3D scanning device, like a laser scanning, structured light scanning, and/or modulated light scanning device. 3D scanning devices may obtain geometry information by moving one or more laser heads, structured light, and/or modulated light cameras relative to the object or scene being scanned. The geometry information may be used to construct a 3D mesh.

As used herein, the terms “computer program medium” and “computer readable medium” are used to refer to tangible storage media, such as removable storage units 1416 and 1418 or a hard disk installed in hard disk drive 1410. These computer program products are means for providing software to computer system 1400. Computer programs (also called computer control logic) may be stored in main memory 1406 and/or secondary memory 1408. Computer programs may also be received via communications interface 1420. Such computer programs, when executed, enable the computer system 1400 to implement the present disclosure as discussed herein. In particular, the computer programs, when executed, enable processor 1404 to implement the processes of the present disclosure, such as any of the methods described herein. Accordingly, such computer programs represent controllers of the computer system 1400.

In another embodiment, features of the disclosure may be implemented in hardware using, for example, hardware components such as application-specific integrated circuits (ASICs) and gate arrays. Implementation of a hardware state machine to perform the functions described herein will also be apparent to persons skilled in the relevant art(s).

What is claimed is:

1. A method comprising:
subdividing, for a 3-dimensional (3D) mesh, a bash mesh obtained from a bitstream to generate a first subdivided mesh;
subdividing an edge, formed by a first and a second vertex from the first subdivided mesh, to determine a vertex, wherein the subdividing the edge comprises:
determining a pair of vertices, from the first subdivided mesh, used to generate the first vertex; and
determining a refinement vector based on combining vertex normals of the pair of vertices, wherein the vertex is determined based on the refinement vector and a point along the edge; and
reconstructing the 3D mesh based on a second subdivided mesh comprising vertices of the first subdivided mesh and the vertex.

2. The method of claim 1, wherein the vertex is determined based on adding the refinement vector to the point, and wherein the point is a midpoint of the edge.

3. The method of claim 1, wherein the refinement vector is determined based on a linear combination of the vertex normals, and wherein each vertex normals of the vertex normals is weighted by a respective normal weight determined using the edge and the each vertex normal.

4. The method of claim 3, wherein a first normal weight of a first vertex normal of the first vertex is determined based on a dot product of the first vertex normal and a vector defined from the first vertex to the second vertex.

5. The method of claim 1, wherein the determining the refinement vector further comprises:
determining a second pair of vertices, from the first subdivided mesh, used to generate the second vertex, wherein the refinement vector is determined based on a linear combination of:
the vertex normals; and
second vertex normals of the second pair of vertices.

6. The method of claim 5, wherein each vertex normals of the vertex normals is weighted by a respective normal weight determined using the edge and the each vertex normal, and wherein each second vertex normal of the second vertex normals is weighted by a respective second normal weight determined using the edge and the each second vertex normal.

7. The method of claim 1, wherein the reconstructing the 3D mesh comprises:
obtaining, from the bitstream, displacements of second vertices of the second subdivided mesh; and
reconstructing the 3D mesh based on updating the second vertices with the displacements.

8. A decoder comprising:
one or more processors; and
memory storing instructions that, when executed by the one or more processors, cause the decoder to:
subdivide, for a 3-dimensional (3D) mesh, a bash mesh obtained from a bitstream to generate a first subdivided mesh;
subdivide an edge, formed by a first and a second vertex from the first subdivided mesh, to determine a vertex, wherein the subdividing the edge comprises:
determining a pair of vertices, from the first subdivided mesh, used to generate the first vertex; and
determining a refinement vector based on combining vertex normals of the pair of vertices, wherein the vertex is determined based on the refinement vector and a point along the edge; and
reconstruct the 3D mesh based on a second subdivided mesh comprising vertices of the first subdivided mesh and the vertex.

9. The decoder of claim 8, wherein the vertex is determined based on adding the refinement vector to the point, and wherein the point is a midpoint of the edge.

10. The decoder of claim 8, wherein the refinement vector is determined based on a linear combination of the vertex normals, and wherein each vertex normals of the vertex normals is weighted by a respective normal weight determined using the edge and the each vertex normal.

11. The decoder of claim 10, wherein a first normal weight of a first vertex normal of the first vertex is determined based on a dot product of the first vertex normal and a vector defined from the first vertex to the second vertex.

12. The decoder of claim 8, wherein, to determine the refinement vector, the instruction further cause the decoder to:
determine a second pair of vertices, from the first subdivided mesh, used to generate the second vertex, wherein the refinement vector is determined based on a linear combination of:
the vertex normals; and
second vertex normals of the second pair of vertices.

13. The decoder of claim 12, wherein each vertex normals of the vertex normals is weighted by a respective normal weight determined using the edge and the each vertex normal, and wherein each second vertex normal of the second vertex normals is weighted by a respective second normal weight determined using the edge and the each second vertex normal.

14. The decoder of claim 8, wherein to reconstruct the 3D mesh, the instruction further cause the decoder to:
obtain, from the bitstream, displacements of second vertices of the second subdivided mesh; and
reconstruct the 3D mesh based on updating the second vertices with the displacements.

15. A non-transitory computer-readable medium comprising instructions that, when executed by one or more processors of a decoder, cause the decoder to:
subdivide, for a 3-dimensional (3D) mesh, a bash mesh obtained from a bitstream to generate a first subdivided mesh;
subdivide an edge, formed by a first and a second vertex from the first subdivided mesh, to determine a vertex, wherein the subdividing the edge comprises:
determining a pair of vertices, from the first subdivided mesh, used to generate the first vertex; and
determining a refinement vector based on combining vertex normals of the pair of vertices, wherein the vertex is determined based on the refinement vector and a point along the edge; and
reconstruct the 3D mesh based on a second subdivided mesh comprising vertices of the first subdivided mesh and the vertex.

16. The non-transitory computer-readable medium of claim 15, wherein the vertex is determined based on adding the refinement vector to the point, and wherein the point is a midpoint of the edge.

17. The non-transitory computer-readable medium of claim 15, wherein the refinement vector is determined based on a linear combination of the vertex normals, and wherein each vertex normals of the vertex normals is weighted by a respective normal weight determined using the edge and the each vertex normal.

18. The non-transitory computer-readable medium of claim 17, wherein a first normal weight of a first vertex normal of the first vertex is determined based on a dot product of the first vertex normal and a vector defined from the first vertex to the second vertex.

19. The non-transitory computer-readable medium of claim 15, wherein, to determine the refinement vector, the instruction further cause the decoder to:
determine a second pair of vertices, from the first subdivided mesh, used to generate the second vertex, wherein the refinement vector is determined based on a linear combination of:
the vertex normals; and
second vertex normals of the second pair of vertices.

20. The non-transitory computer-readable medium of claim 19, wherein each vertex normals of the vertex normals is weighted by a respective normal weight determined using the edge and the each vertex normal, and wherein each second vertex normal of the second vertex normals is weighted by a respective second normal weight determined using the edge and the each second vertex normal.
